(19) United States
(12) Patent Application Publication
(10) Pub. No.: US 2026/0292236 A1
(43) Pub. Date: Sep. 24, 2026

(54) Signaling Base-Mesh Motion Vectors for Video-Based Mesh Coding

(71) Applicant: Apple Inc., Cupertino, CA (US)

(72) Inventor: Jungsun Kim, Sunnyvale, CA (US)

(73) Assignee: Apple Inc., Cupertino, CA (US)

(21) Appl. No.: 19/474,169

(22) PCT Filed: Apr. 12, 2024
(86) PCT No.: PCT/US2024/024472

§ 371 Date: Oct. 9, 2025

Related U.S. Application Data
(60) Provisional application No. 63/496,329, filed on Apr. 14, 2023.

(51) Int. Cl. H04N 19/52; G06T 9/00

(52) U.S. Cl. CPC H04N 19/52; G06T 9/001

(57) ABSTRACT

A system comprises an encoder configured to compress and encode data for a three-dimensional mesh. To compress the three-dimensional mesh, the encoder determines displacements to be applied to sub-division locations of a base mesh. In addition to signaling displacements, motion vectors for portions of the base mesh (e.g. sub-meshes) may be signaled. In this way, similarities in base mesh structure across multiple moments in time (or within a moment in time frame) may be exploited to further improve compression efficiency.

### PRIORITY CLAIM

This application is a 371 of PCT Application No. PCT/US2024/024472, filed Apr. 12, 2024, which claims benefit of priority to U.S. Provisional Patent Application No. 63/496,329, filed Apr. 14, 2023. The above applications are incorporated herein by reference. To the extent that any material in the incorporated application conflicts with material expressly set forth herein, the material expressly set forth herein controls.

### BACKGROUND

### Technical Field

This disclosure relates generally to compression and decompression of three-dimensional meshes with associated textures or attributes.

### Description of the Related Art

Various types of sensors, such as light detection and ranging (LIDAR) systems, 3-D-cameras, 3-D scanners, etc. may capture data indicating positions of points in three-dimensional space, for example positions in the X, Y, and Z planes. Also, such systems may further capture attribute information in addition to spatial information for the respective points, such as color information (e.g., RGB values), texture information, intensity attributes, reflectivity attributes, motion related attributes, modality attributes, or various other attributes. In some circumstances, additional attributes may be assigned to the respective points, such as a time-stamp when the point was captured. Points captured by such sensors may make up a “point cloud” comprising a set of points each having associated spatial information and one or more associated attributes. In some circumstances, a point cloud may include thousands of points, hundreds of thousands of points, millions of points, or even more points. Also, in some circumstances, point clouds may be generated, for example in software, as opposed to being captured by one or more sensors. In either case, such point clouds may include large amounts of data and may be costly and time-consuming to store and transmit. Also, three-dimensional visual content may also be captured in other ways, such as via 2D images of a scene captured from multiple viewing positions relative to the scene.

Such three-dimensional visual content may be represented by a three-dimensional mesh comprising a plurality of polygons with connected vertices that models a surface of three-dimensional visual content, such as a surface of a point cloud. Moreover, texture or attribute values of points of the three-dimensional visual content may be overlaid on the mesh to represent the attribute or texture of the three-dimensional visual content when modelled as a three-dimensional mesh.

Additionally, a three-dimensional mesh may be generated, for example in software, without first being modelled as a point cloud or other type of three-dimensional visual content. For example, the software may directly generate the three-dimensional mesh and apply texture or attribute values to represent an object.

### SUMMARY OF EMBODIMENTS

In some embodiments, a system includes one or more sensors configured to capture points representing an object in a view of the sensor and to capture texture or attribute values associated with the points of the object. The system also includes one or more computing devices storing program instructions, that when executed, cause the one or more computing devices to generate a three-dimensional mesh that models the points of the object using vertices and connections between the vertices that define polygons of the three-dimensional mesh. Also, in some embodiments, a three-dimensional mesh may be generated without first being captured by one or more sensors. For example, a computer graphics program may generate a three-dimensional mesh with an associated texture or associated attribute values to represent an object in a scene, without necessarily generating a point cloud that represents the object.

In some embodiments, an encoder system includes one or more computing devices storing program instructions that when executed by the one or more computing devices, further cause the one or more computing devices to determine a plurality of patches for the attributes three-dimensional mesh and a corresponding attribute map that maps the attribute patches to the geometry of the mesh.

The encoder system may further encode the geometry of the mesh by encoding a base mesh and displacements of vertices relative to the base mesh. A compressed bit stream may include a compressed base mesh, compressed displacement values, and compressed attribute information. In order to improve compression efficiency, coding units may be used to encode portions of the mesh. For example, encoding units may comprise tiles of the mesh, wherein each tile comprises independently encoded segments of the mesh. As another example, a coding unit may include a patch made up of several sub-meshes of the mesh, wherein the sub-meshes exploit dependencies between the sub-meshes and are therefore not independently encoded. Also, higher level coding units, such as patch groups may be used. Different encoding parameters may be defined in the bit stream to apply to different coding units. For example, instead of having to repeatedly signal the encoding parameters, a commonly signaled coding parameter may be applied to members of a given coding unit, such as sub-meshes of a patch, or a mesh portion that makes up a tile. Some example encoding parameters that may be used include entropy coding parameters, intra-frame prediction parameters, inter-frame prediction parameters, local or sub-mesh indices, amongst various others.

### BRIEF DESCRIPTION OF THE DRAWINGS

FIG. 1 illustrates example input information for defining a three-dimensional mesh, according to some embodiments.

FIG. 2 illustrates an alternative example of input information for defining a three-dimensional mesh, wherein the input information is formatted according to an object format, according to some embodiments.

FIG. 3 illustrates an example pre-processor and encoder for encoding a three-dimensional mesh, according to some embodiments.

FIG. 4 illustrates a more-detailed view of an example intra-frame encoder, according to some embodiments.

FIG. 5 illustrates an example intra-frame decoder for decoding a three-dimensional mesh, according to some embodiments.

FIG. 6 illustrates a more-detailed view of an example inter-frame encoder, according to some embodiments.

FIG. 7 illustrates an example inter-frame decoder for decoding a three-dimensional mesh, according to some embodiments.

FIGS. 8A-8B illustrate segmentation of a mesh into multiple tiles, according to some embodiments.

FIG. 9 illustrates a mesh segmented into two tiles, each comprising sub-meshes, according to some embodiments.

FIGS. 10A-10D illustrate adaptive sub-division based on edge subdivision rules for shared edges, according to some embodiments.

FIGS. 11A-11C illustrate adaptive sub-division for adjacent patches, wherein shared edges are sub-divided in a way that ensures vertices of adjacent patches align with one another, according to some embodiments.

FIG. 12 illustrates example components of a compressed bit stream for a dynamic mesh, according to some embodiments.

FIG. 13 is a flowchart illustrating a process of reconstructing a dynamic mesh using a base mesh and displacement information, wherein only a portion of the base mesh corresponding to a sub-set of all sub-meshes of the base mesh is used, according to some embodiments.

FIG. 14 illustrates different prediction modes that may be applied to predict various portions (e.g. sub-meshes) of a base mesh, according to some embodiments.

FIG. 15 is a flow chart illustrating a process for compressing a dynamic mesh using sub-mesh data units, according to some embodiments.

FIG. 16 illustrates an example computer system that may implement an encoder or decoder, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f), for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

As data acquisition and display technologies have become more advanced, the ability to capture volumetric content comprising thousands or millions of points in 2-D or 3-D space, such as via LIDAR systems, has increased. Also, the development of advanced display technologies, such as virtual reality or augmented reality systems, has increased potential uses for volumetric content. However, volumetric content files are often very large and may be costly and time-consuming to store and transmit. For example, communication of volumetric content over private or public networks, such as the Internet, may require considerable amounts of time and/or network resources, such that some uses of volumetric content, such as real-time uses, may be limited. Also, storage requirements of volumetric content files may consume a significant amount of storage capacity of devices storing the volumetric content files, which may also limit potential applications for using volumetric content data.

In some embodiments, an encoder may be used to generate compressed volumetric content to reduce costs and time associated with storing and transmitting large volumetric content files. In some embodiments, a system may include an encoder that compresses attribute and/or spatial information of volumetric content such that the volumetric content file may be stored and transmitted more quickly than non-compressed volumetric content and in a manner that the volumetric content file may occupy less storage space than non-compressed volumetric content.

In some embodiments, such encoders and decoders or other encoders and decoders described herein may be adapted to additionally or alternatively encode three-degree of freedom plus (3DOF+) scenes, visual volumetric content, such as MPEG V3C scenes, immersive video scenes, such as MPEG MIV, etc.

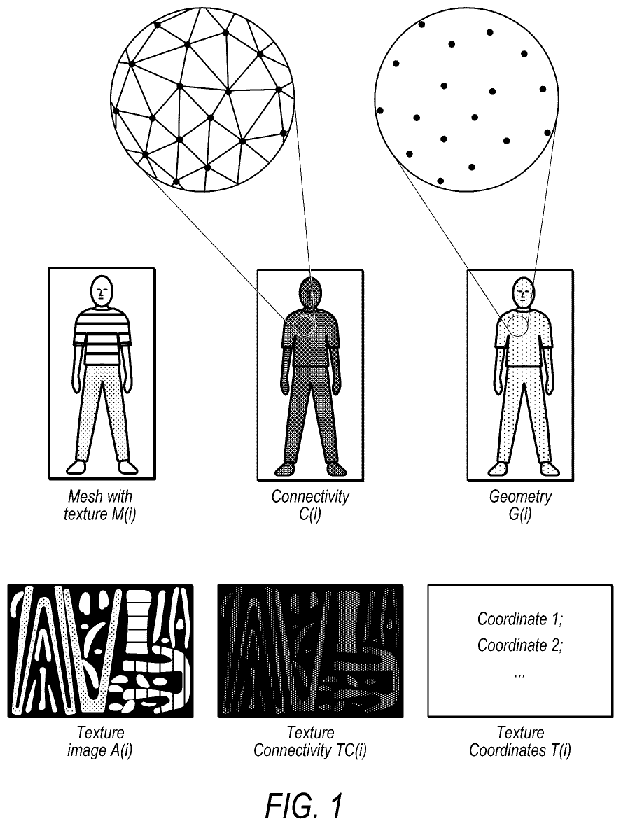

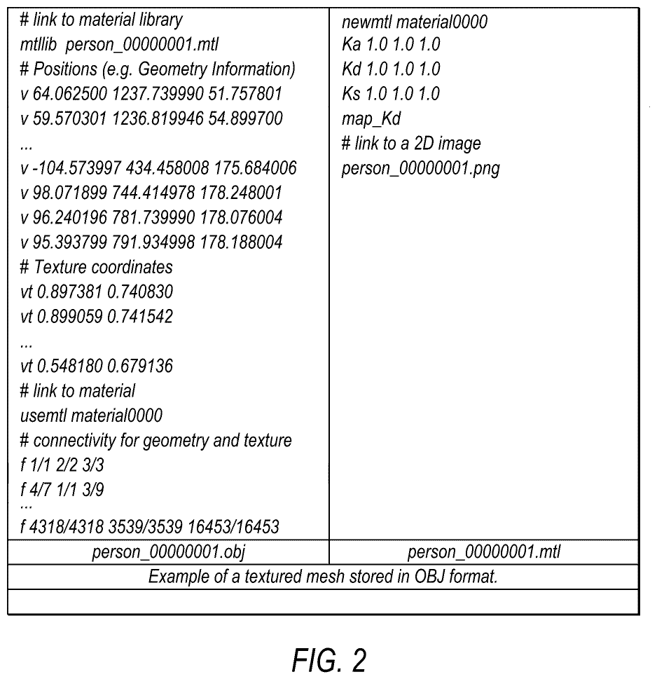

In some embodiments, a static or dynamic mesh that is to be compressed and/or encoded may include a set of 3D Meshes M(0), M(1), M(2), . . . , M(n). Each mesh M(i) may be defined by a connectivity information C(i), a geometry information G(i), texture coordinates T(i) and texture connectivity TC(i). For each mesh M(i), one or multiple 2D images A(i, 0), A(i, 1) . . . , A(i, D−1) describing the textures or attributes associated with the mesh may be included. For example, FIG. 1 illustrates an example static or dynamic mesh M(i) comprising connectivity information C(i), geometry information G(i), texture images A(i), texture connectivity information TC(i), and texture coordinates information T(i). Also, FIG. 2 illustrates an example of a textured mesh stored in object (OBJ) format.

For example, the example texture mesh stored in the object format shown in FIG. 2 includes geometry information listed as X, Y, and Z coordinates of vertices and texture coordinates listed as two dimensional (2D) coordinates for vertices, wherein the 2D coordinates identify a pixel location of a pixel storing texture information for a given vertex. The example texture mesh stored in the object format also includes texture connectivity information that indicates mappings between the geometry coordinates and texture coordinates to form polygons, such as triangles. For example, a first triangle is formed by three vertices, where a first vertex (1/1) is defined as the first geometry coordinate (e.g., 64.062500, 1237.739990, 51.757801), which corresponds with the first texture coordinate (e.g., 0.0897381, 0.740830). The second vertex (2/2) of the triangle is defined as the second geometry coordinate (e.g., 59.570301, 1236.819946, 54.899700), which corresponds with the second texture coordinate (e.g., 0.899059, 0.741542). Finally, the third vertex of the triangle corresponds to the third listed geometry coordinate which matches with the third listed texture coordinate. However, note that in some instances a vertex of a polygon, such as a triangle may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

In some embodiments, the geometry information G(i) may represent locations of vertices of the mesh in 3D space and the connectivity C(i) may indicate how the vertices are to be connected together to form polygons that make up the mesh M(i). Also, the texture coordinates T(i) may indicate locations of pixels in a 2D image that correspond to vertices of a corresponding sub-mesh. Attribute patch information may indicate how the texture coordinates defined with respect to a 2D bounding box map into a three-dimensional space of a 3D bounding box associated with the attribute patch based on how the points were projected onto a projection plane for the attribute patch. Also, the texture connectivity information TC(i) may indicate how the vertices represented by the texture coordinates T(i) are to be connected together to form polygons of the sub-meshes. For example, each texture or attribute patch of the texture image A(i) may correspond to a corresponding sub-mesh defined using texture coordinates T(i) and texture connectivity TC(i).

In some embodiments, a mesh encoder may perform a patch generation process, wherein the mesh is subdivided into a set of sub-meshes. The sub-meshes may correspond to the connected components of the texture connectivity or may be different sub-meshes than the texture connectivity of the mesh. In some embodiments, a number and a size of sub-meshes to be determined may be adjusted to balance discontinuities and flexibility to update the mesh, such as via inter-prediction. For example, smaller sub-meshes may allow for a finer granularity of updates to change a particular region of a mesh, such as at a subsequent moment in time using an inter-prediction process. But, a higher number of sub-meshes may introduce more discontinuities.

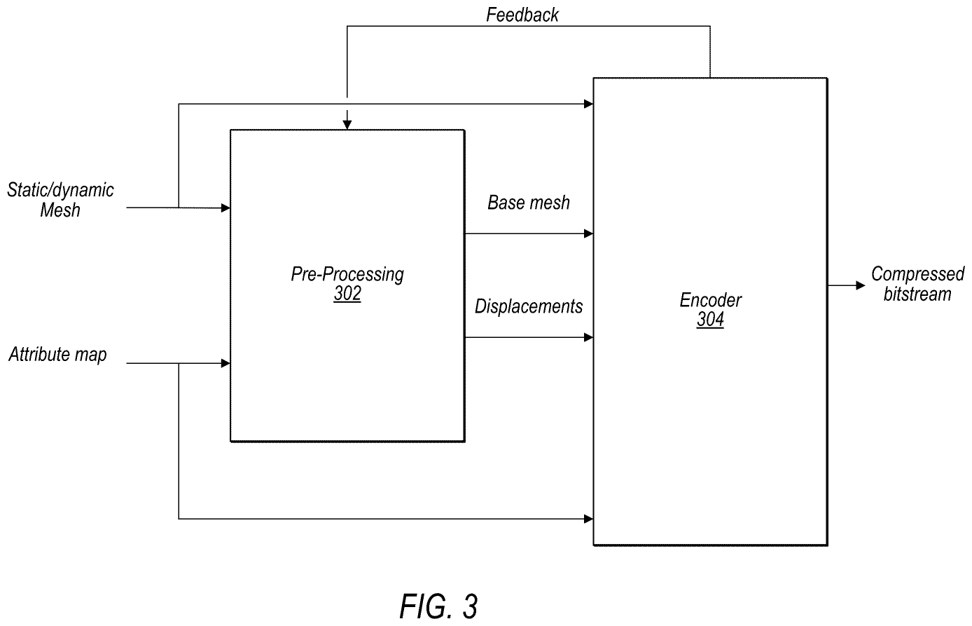

FIG. 3 illustrates a high-level block-diagram of an encoding process in some embodiments. Note that the feedback loop during the encoding process makes it possible for the encoder to guide the pre-processing step and change its parameters to achieve the best possible compromise according to various criteria, such as: rate-distortion, encoding/decoding complexity, random access, reconstruction complexity, terminal capabilities, encoder/decoder power consumption, network bandwidth and latency, and/or other factors.

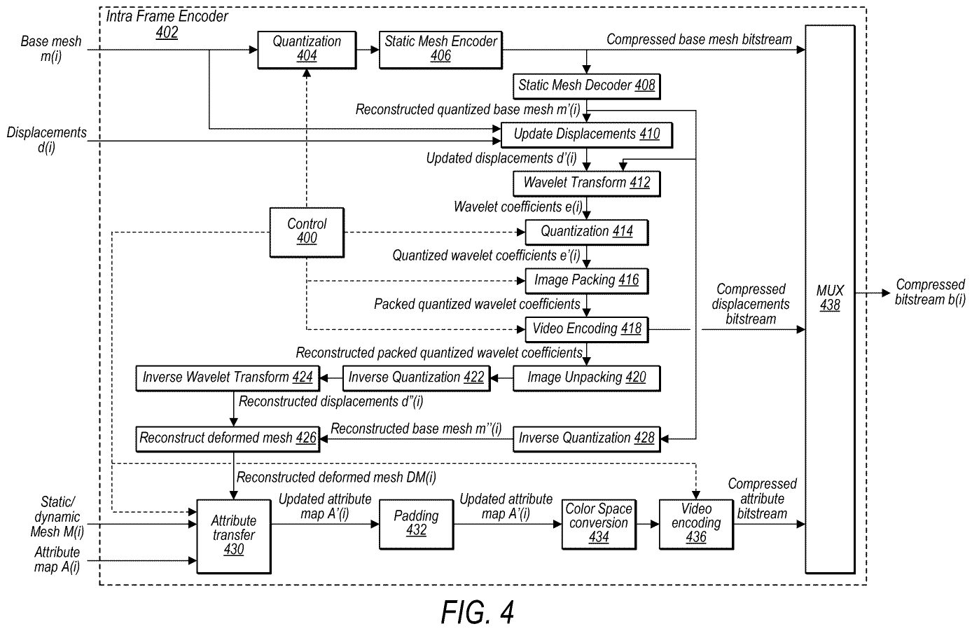

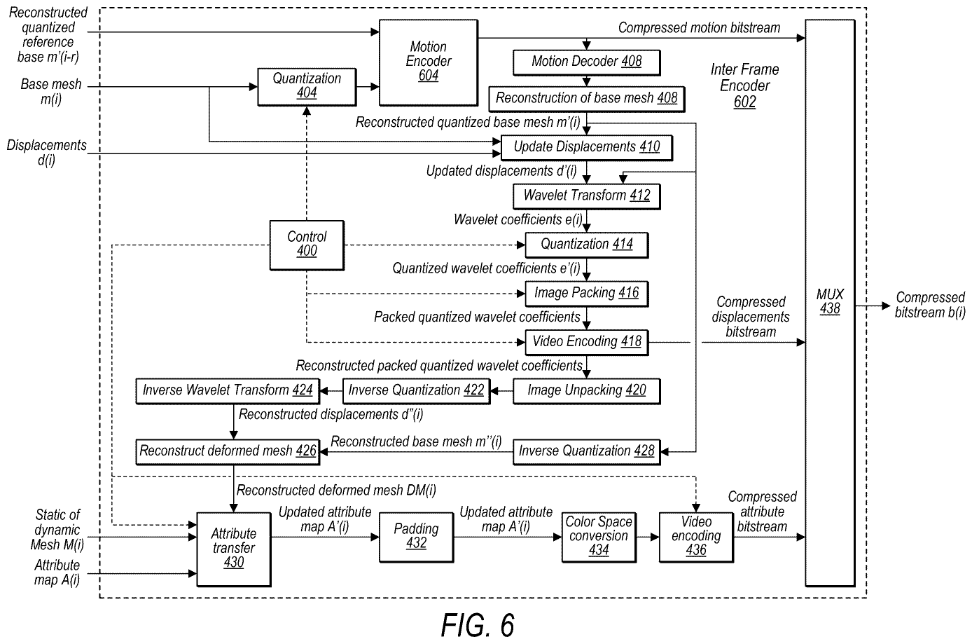

A mesh that could be either static or dynamic is received at pre-processing 302. Also, an attribute map representing how attribute images (e.g., texture images) for the static/dynamic mesh are to be mapped to the mesh is received at pre-processing module 302. For example, the attribute map may include texture coordinates and texture connectivity for texture images for the mesh. The pre-processing module 302 separates the static/dynamic mesh into a base mesh and displacements. Where the displacements represent how vertices are to be displaced to re-create the original static/dynamic mesh from the base mesh. For example, in some embodiments, vertices included in the original static/dynamic mesh may be omitted from the base mesh (e.g., the base mesh may be a compressed version of the original static/dynamic mesh). As will be discussed in more detail below, a decoder may predict additional vertices to be added to the base mesh, for example by sub-dividing edges between remaining vertices included in the base mesh. In such an example, the displacements may indicate how the original vertices of the base mesh and the additional vertices added at the subdivision locations are to be displaced, wherein the displacement of the original and added vertices modifies a partially reconstructed version of the mesh to better represent the original static/dynamic mesh. For example, FIG. 4 illustrates a detailed intra frame encoder 402 that may be used to encode a base mesh m(i) and displacements d(i) for added vertices. For dynamic meshes, an inter frame encoder, such as shown in FIG. 6 may be used. As can be seen in FIG. 6, instead of signaling a new base mesh for each frame, a base mesh for a current time frame can be compared to a reconstructed quantized reference base mesh m′(i-r) (e.g., the reconstructed base mesh that the decoder will see from the previous time frame) and motion vectors to represent how the current base mesh has changed relative to the reference base mesh may be encoded in lieu of encoding a new base mesh for each frame. Note that the motion vectors may not be encoded directly but may be further compressed to take advantage of relationships between the motion vectors.

The separated base mesh and displacements that have been separated by pre-processing module 302 are provided to encoder 304, which may be an intra-frame encoder as shown in FIG. 4 or an inter-frame encoder as shown in FIG. 6. Also, the attribute map is provided to the encoder 304. In some embodiments, the original static/dynamic mesh may also be provided to the encoder 304, in addition to the separated out base mesh and displacements. For example, the encoder 304 may compare a reconstructed version of the static/dynamic mesh (that has been reconstructed by applying reconstruction processes to the base mesh and displacements) in order to determine geometric distortion. In some embodiments, an attribute transfer process may be performed to adjust the attribute values of the attribute images to account for this slight geometric distortion. In some embodiments, feedback may be provided back to pre-processing 302, for example to reduce distortion, by changing how original static/dynamic mesh is decimated to generate the base mesh. In some embodiments, feedback may be provided back to pre-processing 302, for example to be used for generating the base meshes of the future frames. Note that in some embodiments an intra-frame encoder and an inter-frame encoder may be combined into a single encoder that includes logic to toggle between intra-frame encoding and inter-frame encoding. The output of the encoder 304 is a compressed bit stream representing the original static/dynamic mesh and its associated attributes/textures.

With regard to mesh decimation, in some embodiments, a portion of a surface of a static/dynamic mesh may be thought of as an input 2D curve (represented by a 2D polyline), referred to as an “original” curve. The original curve may be first down-sampled to generate a base curve/polyline, referred to as a “decimated” curve. A subdivision scheme, such as those described herein, may then be applied to the decimated polyline to generate a “subdivided” curve. For instance, a subdivision scheme using an iterative interpolation scheme may be applied. The subdivision scheme may include inserting at each iteration a new point in the middle of each edge of the polyline. The inserted points represent additional vertices that may be moved by the displacements.

For example, the subdivided polyline is then deformed to get a better approximation of the original curve. More precisely, a displacement vector is computed for each vertex of the subdivided mesh such that the shape of the displaced curve approximates the shape of the original curve. An advantage of the subdivided curve is that it has a subdivision structure that allows efficient compression, while it offers a faithful approximation of the original curve. The compression efficiency is obtained thanks to the following properties:
The decimated/base curve has a low number of vertices and requires a limited number of bits to be encoded/transmitted.
The subdivided curve is automatically generated by the decoder once the base/decimated curve is decoded (e.g., no need to signal or hardcode at the decoder any information other than the subdivision scheme type and subdivision iteration count).
The displaced curve is generated by decoding and applying the displacement vectors associated with the subdivided curve vertices. Besides allowing for spatial/quality scalability, the subdivision structure enables efficient wavelet decomposition, which offers high compression performance (e.g., with respect to rate-distortion performance).

For example, FIG. 4 illustrates a more-detailed view of an example intra-frame encoder, according to some embodiments.

In some embodiments, intra-frame encoder 402 receives base mesh m(i), displacements d(i), the original static/dynamic mesh M(i) and attribute map A(i). The base mesh m(i) is provided to quantization module 404, wherein aspects of the base mesh may (optionally) be further quantized. In some embodiments, various mesh encoders may be used to encode the base mesh. Also, in some embodiments, intra-frame encoder 402 may allow for customization, wherein different respective mesh encoding schemes may be used to encode the base mesh. For example, static mesh encoder 406 may be a selected mesh encoder selected from a set of viable mesh encoder, such as a DRACO encoder (or another suitable encoder). The encoded base mesh, that has been encoded by static mesh encoder 406 is provided to multiplexer (MUX) 438 for inclusion in the compressed bitstream b(i). Additionally, the encoded base mesh is provided to static mesh decoder in order to generate a reconstructed version of the base mesh (that a decoder will see). This reconstructed version of the base mesh is used to update the displacements d(i) to take into account any geometric distortion between the original base mesh and a reconstructed version of the base mesh (that a decoder will see). For example, static mesh decoder 408 generates reconstructed quantized base mesh m′(i) and provides the reconstructed quantized base mesh m′(i) to displacement update module 410, which also receives the original base mesh and the original displacement d(i). The displacement update module 410 compares the reconstructed quantized base mesh m′(i) (that the decoder will see) to the base mesh m(i) and adjusts the displacements d(i) to account for differences between the base mesh m(i) and the reconstructed quantized base mesh m′(i). These updated displacements d′(i) are provided to wavelet transform 412 which applies a wavelet transformation to further compress the updated displacements d′(i) and outputs wavelet coefficients e(i), which are provided to quantization module 414 which generated quantized wavelet coefficients e′(i). The quantized wavelet coefficients may then be packed into a 2D image frame via image packing module 416, wherein the packed 2D image frame is further video encoded via video encoding 418. The encoded video images are also provided to multiplexer (MUX) 438 for inclusion in the compressed bit stream b(i). Also, in some embodiments, the displacement values (such as are indicated in the generated quantized wavelet coefficients e′(i) or indicated using other compression schemes) may be encoded at least partially outside of the video sub-bitstream, such as in their own displacement data sub-bitstream, in the base mesh sub-bitstream, or in an atlas data sub-bitstream.

In addition, in order to account for any geometric distortion introduced relative to the original static/dynamic mesh, an attribute transfer process 430 may be used to modify attributes to account for differences between a reconstructed deformed mesh DM(i) and the original static/dynamic mesh.

For example, video encoding 418 may further perform video decoding (or a complimentary video-decoding module may be used (which is not shown in FIG. 4)). This produces reconstructed packed quantized wavelet coefficients that are unpacked via image unpacking module 420. Furthermore, inverse quantization may be applied via inverse quantization module 422 and inverse wavelet transform 424 may be applied to generate reconstructed displacements d″(i). In some embodiments, other decoding techniques may be used to generate reconstructed displacements d″(i), such as decoding displacements signaled in atlas data sub-bitstream, a displacement data sub-bitstream, or the base mesh-sub-bitstream. Also, the reconstructed quantized base mesh m′(i) that was generated by static mesh decoder 408 may be inverse quantized via inverse quantization module 428 to generate reconstructed base mesh m″(i). The reconstructed deformed mesh generation module 426 applies the reconstructed displacements d″(i) to the reconstructed base mesh m″(i) to generate reconstructed deformed mesh DM(i). Note that the reconstructed deformed mesh DM(i) represents the reconstructed mesh that a decoder will generate, and accounts for any geometric deformation resulting from losses introduced in the encoding process.

Attribute transfer module 430 compares the geometry of the original static/dynamic mesh M(i) to the reconstructed deformed mesh DM(i) and updates the attribute map to account for any geometric deformations, this updated attribute map is output as updated attribute map A′(i). The updated attribute map A′(i) is then padded, wherein a 2D image comprising the attribute images is padded such that spaces not used to communicate the attribute images have a padding applied. In some embodiments, a color space conversion is optionally applied at color space conversion module 434. For example, an RGB color space used to represent color values of the attribute images may be converted to a YCbCr color space, also color space sub-sampling may be applied such as 4:2:0, 4:0:0, etc. color space sub-sampling. The updated attribute map A′(i) that has been padded and optionally color space converted is then video encoded via video encoding module 436 and is provided to multiplexer 438 for inclusion in compressed bitstream b(i).

In some embodiments, a controller 400 may coordinate the various quantization and inverse quantization steps as well as the video encoding and decoding steps such that the inverse quantization “undoes” the quantization and such that the video decoding “undoes” the video encoding. Also, the attribute transfer module 430 may take into account the level of quantization being applied based on communications from the controller 400.

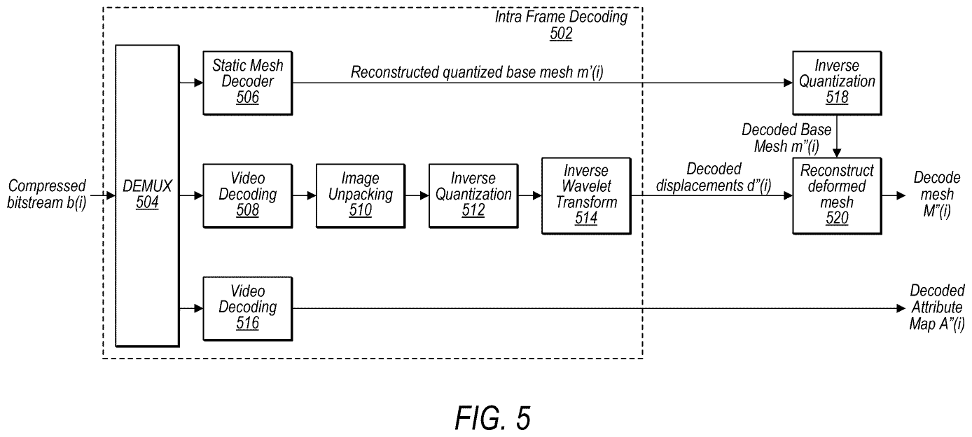

FIG. 5 illustrates an example intra-frame decoder for decoding a three-dimensional mesh, according to some embodiments.

Intra frame decoder 502 receives a compressed bitstream b(i), such as the compressed bit stream generated by the intra frame encoder 402 shown in FIG. 4. Demultiplexer (DEMUX) 504 parses the bitstream into a base mesh sub-component, a displacement sub-component, and an attribute map sub-component. In some embodiments, the displacement sub-component may be signaled in a displacement data sub-bitstream or may be at least partially signaled in other sub-bitstreams, such as an atlas data sub-bitstream, a base mesh sub-bitstream, or a video sub-bitstream. In such a case, displacement decoder 522 decodes the displacement sub-bitstream and/or atlas decoder 524 decodes the atlas sub-bitstream.

Static mesh decoder 506 decodes the base mesh sub-component to generate a reconstructed quantized base mesh m′(i), which is provided to inverse quantization module 518, which in turn outputs decoded base mesh m″(i) and provides it to reconstructed deformed mesh generator 520.

In some embodiments, a portion of the displacement sub-component of the bit stream is provided to video decoding 508, wherein video encoded image frames are video decoded and provided to image unpacking 510. Image unpacking 510 extracts the packed displacements from the video decoded image frame and provides them to inverse quantization 512 wherein the displacements are inverse quantized. Also, the inverse quantized displacements are provided to inverse wavelet transform 514, which outputs decoded displacements d″(i). Reconstructed deformed mesh generator 520 applies the decoded displacements d″(i) to the decoded base mesh m″(i) to generate a decoded static/dynamic mesh M″(i). The decoded displacement may come from any combination of the video sub-bitstream, the atlas data sub-bitstream, the base-mesh sub-bitstream and/or a displacement data sub-bitstream. Also, the attribute map sub-component is provided to video decoding 516, which outputs a decoded attribute map A″(i). A reconstructed version of the three-dimensional visual content can then be rendered at a device associated with the decoder using the decoded mesh M″(i) and the decoded attribute map A″(i).

As shown in FIG. 5, a bitstream is de-multiplexed into three or more separate sub-streams:
mesh sub-stream,
displacement sub-stream for positions and potentially for each vertex attribute, and
attribute map sub-stream for each attribute map.

The mesh sub-stream is fed to the mesh decoder to generate the reconstructed quantized base mesh m′(i). The decoded base mesh m″(i) is then obtained by applying inverse quantization to m′(i). The proposed scheme is agnostic of which mesh codec is used. The mesh codec used could be specified explicitly in the bitstream or could be implicitly defined/fixed by the specification or the application.

The displacement sub-stream could be decoded by a video/image decoder. The generated image/video is then un-packed and inverse quantization is applied to the wavelet coefficients. In an alternative embodiment, the displacements could be decoded by dedicated displacement data decoder or the atlas decoder. The proposed scheme is agnostic of which codec/standard is used. Image/video codecs such as [HEVC][AVC][AV1][AV2][JPEG][JPEG2000] could be used. The motion decoder used for decoding mesh motion information or a dictionary-based decoder such as ZIP could be for example used as the dedicated displacement data decoder. The decoded displacement d″(i) is then generated by applying the inverse wavelet transform to the unquantized wavelet coefficients. The final decoded mesh is generated by applying the reconstruction process to the decoded base mesh m″(i) and adding the decoded displacement field d″(i).

The attribute sub-stream is directly decoded by the video decoder and the decoded attribute map A″(i) is generated as output. The proposed scheme is agnostic of which codec/standard is used. Image/video codecs such as [HEVC][AVC][AV1][AV2][JPEG][JPEG2000] could be used. Alternatively, an attribute sub-stream could be decoded by using non-image/video decoders (e.g., using a dictionary-based decoder such as ZIP). Multiple sub-streams, each associated with a different attribute map, could be decoded. Each sub-stream could use a different codec.

FIG. 6 illustrates a more-detailed view of an example inter-frame encoder, according to some embodiments.

In some embodiments, inter frame encoder 602 may include similar components as the intra-frame encoder 402, but instead of encoding a base mesh, the inter-frame encoder may encode motion vectors that can be applied to a reference mesh to generate, at a decoder, a base mesh.

For example, in the case of dynamic meshes, a temporally consistent re-meshing process is used, which may produce a same subdivision structure that is shared by the current mesh M′(i) and a reference mesh M′(j). Such a coherent temporal re-meshing process makes it possible to skip the encoding of the base mesh m(i) and re-use the base mesh m(j) associated with the reference frame M(j). This could also enable better temporal prediction for both the attribute and geometry information. More precisely, a motion field f(i) describing how to move the vertices of m(j) to match the positions of m(i) may be computed and encoded. Such process is described in FIG. 6. For example, motion encoder 406 may generate the motion field f(i) describing how to move the vertices of m(j) to match the positions of m(i).

In some embodiments, the base mesh m(i) associated with the current frame is first quantized (e.g., using uniform quantization) and encoded by using a static mesh encoder. The proposed scheme is agnostic of which mesh codec is used. The mesh codec used could be specified explicitly in the bitstream by encoding a mesh codec ID or could be implicitly defined/fixed by the specification or the application.

Depending on the application and the targeted bitrate/visual quality, the encoder could optionally encode a set of displacement vectors associated with the subdivided mesh vertices, referred to as the displacement field d(i).

The reconstructed quantized base mesh m′(i) (e.g., output of reconstruction of base mesh 408) is then used to update the displacement field d(i) (at update displacements module 410) to generate an updated displacement field d′(i) so it takes into account the differences between the reconstructed base mesh m′(i) and the original base mesh m(i). By exploiting the subdivision surface mesh structure, a wavelet transform is then applied, at wavelet transform 412, to d′(i) and a set of wavelet coefficients are generated. The wavelet coefficients are then quantized, at quantization 414, packed into a 2D image/video (at image packing 416), and compressed by using an image/video encoder (at video encoding 418). The encoding of the wavelet coefficients may be lossless or lossy. The reconstructed version of the wavelet coefficients is obtained by applying image unpacking and inverse quantization to the reconstructed wavelet coefficients video generated during the video encoding process (e.g., at 420, 422, and 424). Reconstructed displacements d″(i) are then computed by applying the inverse wavelet transform to the reconstructed wavelet coefficients. A reconstructed base mesh m″(i) is obtained by applying inverse quantization to the reconstructed quantized base mesh m′(i). The reconstructed deformed mesh DM(i) is obtained by subdividing m″(i) and applying the reconstructed displacements d″(i) to its vertices.

Since the quantization step or/and the mesh compression module may be lossy, a reconstructed quantized version of m(i), denoted as m′(i), is computed. If the mesh information is losslessly encoded and the quantization step is skipped, m(i) would exactly match m′(i).

As shown in FIG. 6, a reconstructed quantized reference base mesh m′(j) is used to predict the current frame base mesh m(i). The pre-processing module 302 described in FIG. 3 could be configured such that m(i) and m(j) share the same:
number of vertices,
connectivity,
texture coordinates, and
texture connectivity.

The motion field f(i) is computed by considering the quantized version of m(i) and the reconstructed quantized base mesh m′(j). Since m′(j) may have a different number of vertices than m(j) (e.g., vertices may get merged/removed), the encoder keeps track of the transformation applied to m(j) to get m′(j) and applies it to m(i) to guarantee a 1-to-1 correspondence between m′(j) and the transformed and quantized version of m(i), denoted m*(i). The motion field f(i) is computed by subtracting the quantized positions p(i, v) of the vertex v of m*(i) from the positions p(j, v) of the vertex v of m′(j):

$$f ( i , v ) = p ( i , v ) - p ( j , v )$$

The motion field is then further predicted by using the connectivity information of m′(j) and is entropy encoded (e.g., context adaptive binary arithmetic encoding could be used).

Since the motion field compression process could be lossy, a reconstructed motion field denoted as f′(i) is computed by applying the motion decoder module 408. A reconstructed quantized base mesh m′(i) is then computed by adding the motion field to the positions of m′(j). The remaining of the encoding process is similar to the Intra frame encoding.

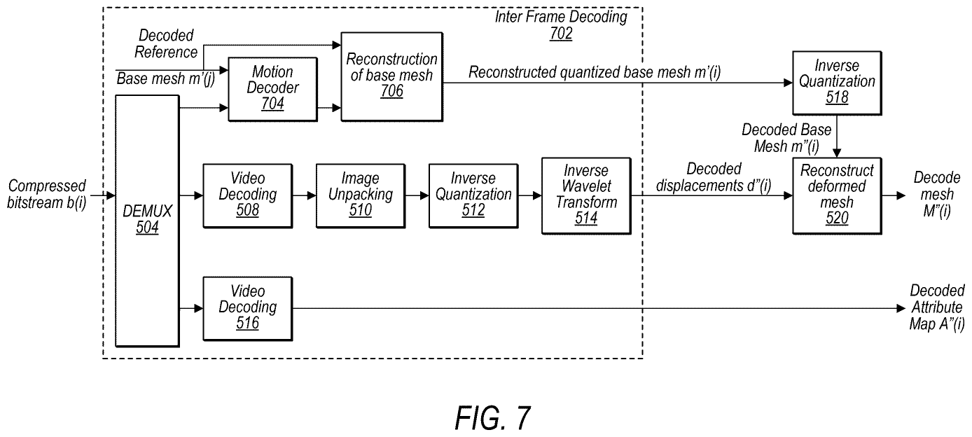

FIG. 7 illustrates an example inter-frame decoder for decoding a three-dimensional mesh, according to some embodiments.

Inter frame decoder 702 includes similar components as intra frame decoder 502 shown in FIG. 5. However, instead of receiving a directly encoded base mesh, the inter frame decoder 702 reconstructs a base mesh for a current frame based on motion vectors of a displacement field relative to a reference frame. For example, inter-frame decoder 702 includes motion field/vector decoder 704 and reconstruction of base mesh module 706.

In a similar manner to the intra-frame decoder, the inter-frame decoder 702 separates the bitstream into three separate sub-streams:
a motion sub-stream,
a displacement sub-stream, and
an attribute sub-stream.

The motion sub-stream is decoded by applying the motion decoder 704. The proposed scheme is agnostic of which codec/standard is used to decode the motion information. For instance, any motion decoding scheme could be used. The decoded motion is then optionally added to the decoded reference quantized base mesh m′(j) to generate the reconstructed quantized base mesh m′(i), i.e., the already decoded mesh at instance j can be used for the prediction of the mesh at instance i. Afterwards, the decoded base mesh m″(i) is generated by applying the inverse quantization to m′(i).

The displacement and attribute sub-streams are decoded in a similar manner as in the intra frame decoding process described with regard to FIG. 5. The decoded mesh M″(i) is also reconstructed in a similar manner.

The inverse quantization and reconstruction processes are not normative and could be implemented in various ways and/or combined with the rendering process.

### Divisions of the Mesh and Controlling Encoding to Avoid Cracks

In some embodiments, the mesh may be sub-divided into a set of patches (e.g., sub-parts) and the patches may potentially be grouped into groups of patches, such as a set of patch groups/tiles. In such embodiments, different encoding parameters (e.g., subdivision, quantization, wavelets transform, coordinates system . . . ) may be used to compress each patch or patch group. In some embodiments, in order to avoid cracks at patch boundaries, lossless coding may be used for boundary vertices. Also, quantization of wavelet coefficients for boundary vertices may be disabled, along with using a local coordinate system for boundary vertices.

In some embodiments, scalability may be supported at different levels. For example, temporal scalability may be achieved through temporal sub-sampling and frame re-ordering. Also, quality and spatial scalability may be achieved by using different mechanisms for the geometry/vertex attribute data and the attribute map data. Also, region of interest (ROI) reconstruction may be supported. For example, the encoding process described in the previous sections could be configured to encode an ROI with higher resolution and/or higher quality for geometry, vertex attribute, and/or attribute map data. This is particularly useful to provide a higher visual quality content under tight bandwidth and complexity constraints (e.g., higher quality for the face vs rest of the body). Priority/importance/spatial/bounding box information could be associated with patches, patch groups, tiles, network abstraction layer (NAL) units, and/or sub-bitstreams in a manner that allows the decoder to adaptively decode a subset of the mesh based on the viewing frustum, the power budget, or the terminal capabilities. Note that any combination of such coding units could be used together to achieve such functionality. For instance, NAL units and sub-bitstreams could be used together.

In some embodiments, temporal and/or spatial random access may be supported. Temporal random access could be achieved by introducing IRAPs (Intra Random Access Points) in the different sub-streams (e.g., attribute atlas, video, mesh, motion, and displacement sub-streams). Spatial random access could be supported through the definition and usage of tiles, sub-pictures, patch groups, and/or patches or any combination of these coding units. Metadata describing the layout and relationships between the different units could also need to be generated and included in the bitstream to assist the decoder in determining the units that need to be decoded.

As discussed above, various functionalities may be supported, such as:
Spatial random access,
Adaptive quality allocation (e.g., foveated compression like allocating higher quality to the face vs. the body of a human model),
Region of Interest (ROI) access,
Coding unit level metadata (e.g., object descriptions, bounding box information),
Spatial and quality scalability, and
Adaptive streaming and decoding (e.g., stream/decode high priority regions first).

The disclosed compression schemes allow the various coding units (e.g., patches, patch groups and tiles) to be compressed with different encoding parameters (e.g., subdivision scheme, subdivision iteration count, quantization parameters, etc.), which can introduce compression artefacts (e.g., cracks between patch boundaries). In some embodiments, as further discussed below an efficient (e.g., computational complexity, compression efficiency, power consumption, etc. efficient) strategy may be used that allows the scheme to handle different coding unit parameters without introducing artefacts.

### Mesh Tile

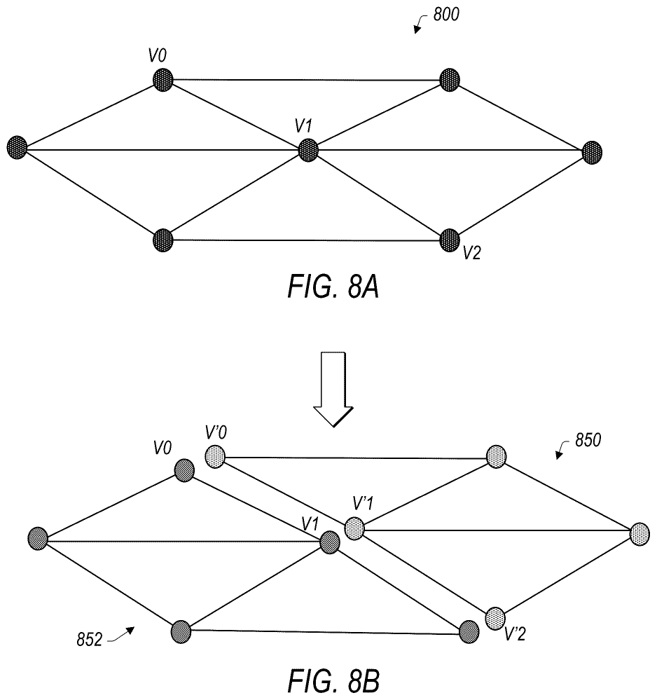

A mesh could be segmented into a set of tiles (e.g., parts/segments), which could be encoded and decoded independently. Vertices/edges that are shared by more than one tile are duplicated as illustrated in FIGS. 8A/8B. Note that mesh 800 is split into two tiles 850 and 852 by duplicating the three vertices {V0, V1, V2}, and the two shared edges {(V0, V1), (V1, V2)}. Said another way, when a mesh is divided into two tiles each of the two tiles include vertices and edges that were previous one set of vertices and edges in the combined mesh, thus the vertices and edges are duplicated in the tiles.

### Sub-Mesh

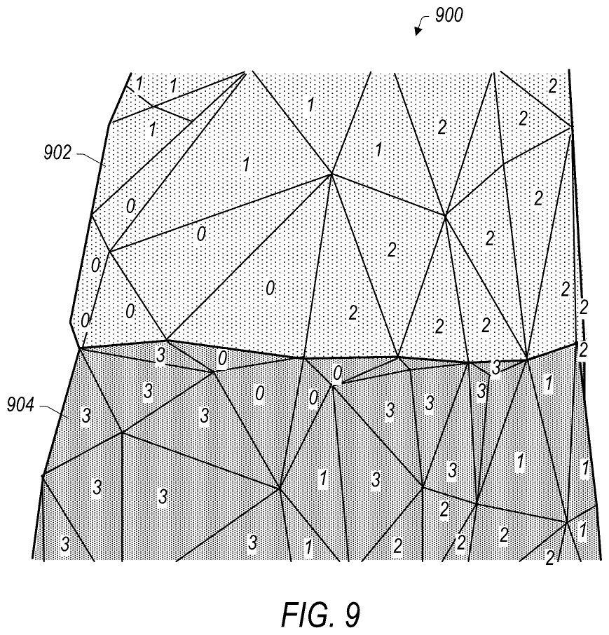

Each tile could be further segmented into a set of sub-meshes, which may be encoded while exploiting dependencies between them. For example, FIG. 9 shows an example of a mesh 900 segmented into two tiles (902 and 904) containing three and four sub-meshes, respectively. For example, tile 902 includes sub-meshes 0, 1, and 2; and tile 904 includes sub-meshes 0, 1, 2, and 3.

The sub-mesh structure could be defined either by:
Explicitly encoding a per face integer attribute that indicates for each face of the mesh the index of the sub-mesh it belongs to, or
Implicitly detecting the connected components (CC) of the mesh with respect to the position's connectivity or the texture coordinate's connectivity or both and by considering each CC as a sub-mesh. The mesh vertices are traversed from neighbor to neighbor, which makes it possible to detect the CCs in a deterministic way. The indices assigned to the CCs start from 0 and are incremented by one each time a new CC is detected.

### Patch

A Patch is a set of sub-meshes. An encoder may explicitly store for each patch the indices of the sub-meshes that belongs to it. In a particular embodiment, a sub-mesh could belong to one or multiple patches (e.g., associate metadata with overlapping parts of the mesh). In another embodiment, a sub-mesh may belong to only a single patch. Vertices located on the boundary between patches are not duplicated. Patches are also encoded while exploiting correlations between them and therefore, they cannot be encoded/decoded independently.

The list of sub-meshes associated with a patch may be encoded by using various strategies, such as:
Entropy coding
Intra-frame prediction
Inter-frame prediction
Local sub-mesh indices (i.e., smaller range)

### Patch Group

A patch group is a set of patches. A patch group is particularly useful to store parameters shared by its patches or to allow a unique handle that could be used to associate metadata with those patches.

In some embodiments, in order to support using different encoding parameters per patch, the following may be used:
The relationship between sub-meshes and patches may be exploited such that each face of the base mesh is assigned a patch ID.
Vertices and edges belonging to a single sub-mesh are assigned the patch ID the sub-mesh belongs to.
Vertices and edges located on the boundary of two or multiple patches are assigned to all the corresponding patches.
When applying the subdivision scheme, the decision to subdivide an edge or not is made by considering the subdivision parameters of all the patches the edge belongs to.

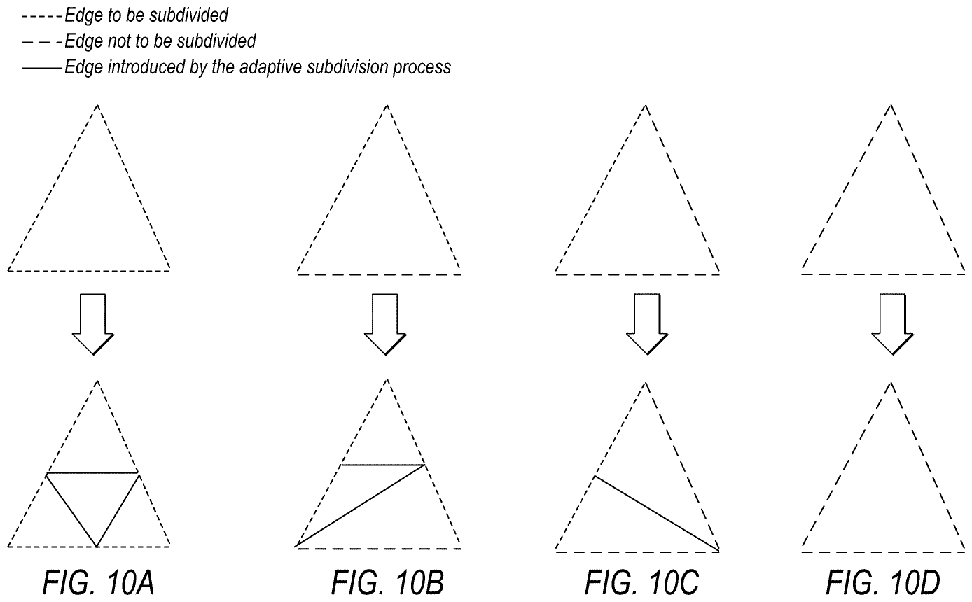

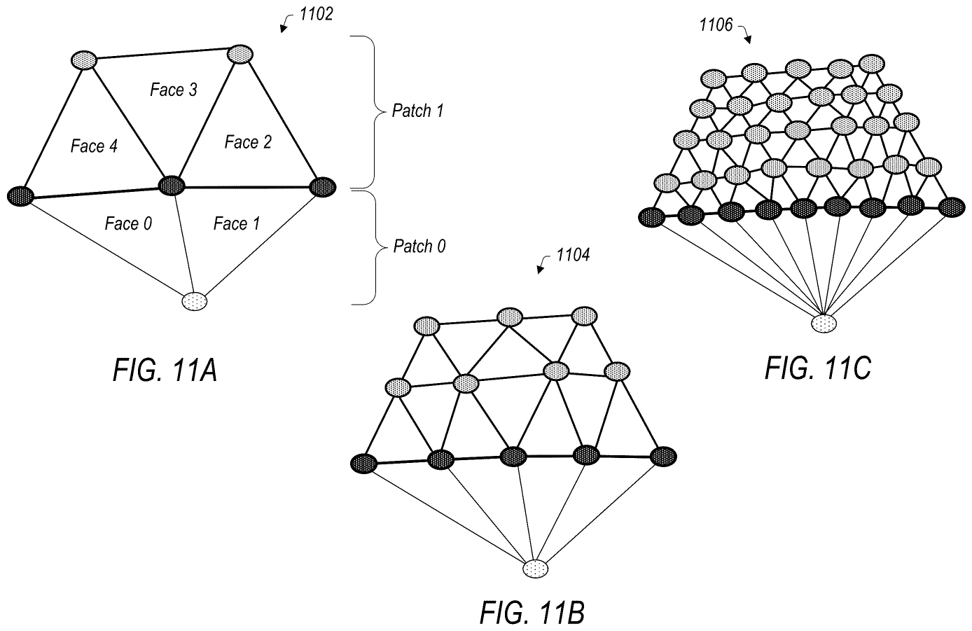

For example, FIGS. 11A-11C illustrate adaptive subdivision based on shared edges. Based on the subdivision decisions as determined in FIGS. 11A-11C (e.g., suppose that there is an edge that belongs to two patches Patch0 and Patch1, Patch0 has a subdivision iteration count of 0, Patch1 has a subdivision iteration count of 2. The shared edge will be subdivided 2 times (i.e., take the maximum of the subdivision counts)), the edges are sub-divided using the sub-division scheme shown in FIGS. 10A-10D. For example, based on the subdivision decisions associated with the different edges, a given one of the adaptive subdivision schemes described in FIGS. 10A-10D is applied. FIGS. 10A-10D show how to subdivide a triangle when 3, 2, 1, or 0 of its edges should be subdivided, respectively. Vertices created after each subdivision iteration are assigned to the patches of their parent edge.

When applying quantization to the wavelet coefficients, the quantization parameters used for a vertex are selected based on the quantization parameters of all the patches the vertex belongs to. For example, suppose that a patch belongs to two patches, Patch0 and Patch1. Patch0 has a quantization parameter QP1. Patch1 has a quantization parameter QP2. The wavelet coefficients associated with the vertex will be quantized using the quantization parameter QP=min(QP1, QP2).

### Mesh Tiles

To support mesh tiles, the encoder could partition the mesh into a set of tiles, which are then encoded/decoded independently by applying any mesh codec or use a mesh codec that natively supports tiled mesh coding.

In both cases, the set of shared vertices located on tile boundaries are duplicated. To avoid cracks appearing between tiles, the encoder could either:
Encode stitching information indicating the mapping between duplicated vertices as follows:
   Encode per vertex tags identifying duplicated vertices (by encoding a vertex attribute with the mesh codec)
   Encode for each duplicated vertex the index of the vertex it should be merged with.
Make sure that the decoded positions and vertex attributes associated with the duplicated vertices exactly match
   Per vertex tags identifying duplicated vertices and code this information as a vertex attribute by using the mesh codec
   Apply an adaptive subdivision scheme as described in the previous section to guarantee a consistent subdivision behavior on tile boundaries
   The encoder needs to maintain the mapping between duplicated vertices and adjust the encoding parameters to guarantee matching values
      Encode the duplicated vertex positions and vertex attribute values in a lossless manner
      Disable wavelet transform (transform bypass mode)
      Perform a search in the encode parameter space to determine a set of parameters that are encoded in the bitstream and guarantee matching positions and attribute values
      Do nothing
   The decoder would decompress the per vertex tag information to be able to identify the duplicated vertices. If different encoding parameters were signaled by the encoder for the duplicated vertices compared to non-duplicated ones, the decoder should adaptively switch between the set of two parameters based on the vertex type (e.g., duplicated vs. non-duplicated).
   The decoder could apply smoothing and automatic stitching as a post processing based on signaling provided by the encoder or based on the analysis on the decoded meshes. In a particular embodiment, a flag is included per vertex or patch to enable/disable such post-processing. This flag could be among others:
      signaled as an SEI message,
      encoded with the mesh codec, or
      signaled in the atlas sub-bitstream.

In another embodiment, the encoder could duplicate regions of the mesh and store them in multiple tiles. This could be done for the purpose of:
Error resilience,
Guard bands, and
D Seamless/adaptive streaming.

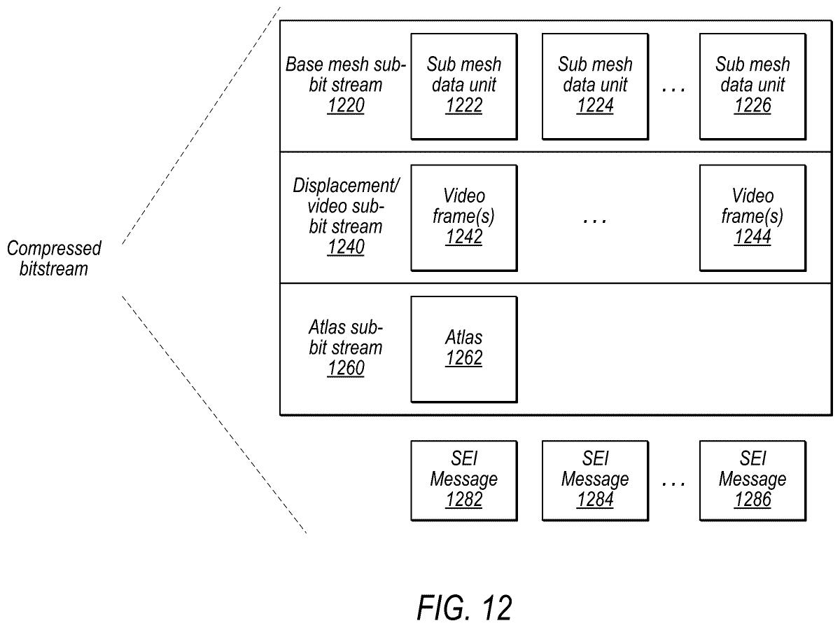

FIG. 12 illustrates example components of a compressed bit stream for a dynamic mesh, according to some embodiments.

In some embodiments, the compressed bit stream may include multiple sub-bit streams, such as base mesh sub-bit stream 1220, displacement/video sub-bit stream 1240, and atlas sub-bit stream 1260. In some embodiments, the atlas sub-bit stream 1260 includes atlas's 1262 that include information for matching displacement values encoded in the video frames 1242 through 1244 to corresponding subdivision locations of the base mesh, which may be encoded using sub-mesh data units 1222, 1224, and 1226. Also, texture coordinates and/or texture connectivity may be signaled in the atlas sub-bit stream 1260.

In some embodiments, the compressed bit stream may include information for individually locating and parsing the sub-mesh data units. For example, SEI message 1282, 1284, and 1286 may indicate byte sizes and vertices counts of the respective sub-mesh data units 1222, 1224, and 1226. Also, such information may alternatively be encoded in NAL unit headers of the sub-mesh data units 1222, 1224, and 1226.

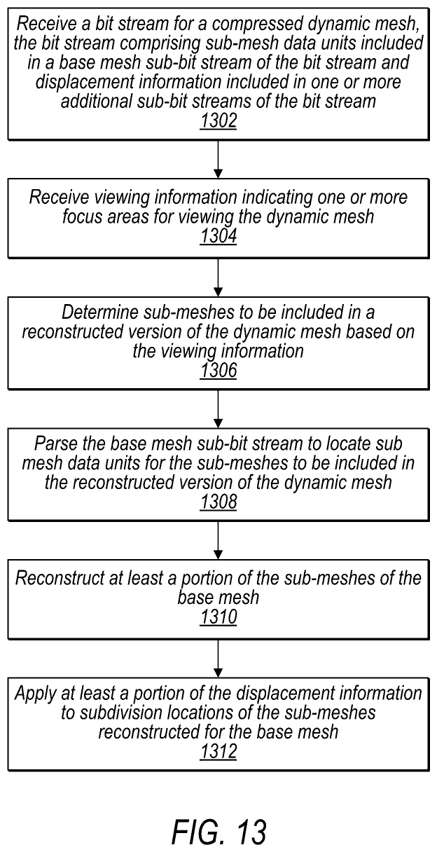

FIG. 13 is a flowchart illustrating a process of reconstructing a dynamic mesh using a base mesh and displacement information, wherein only a portion of the base mesh corresponding to a sub-set of all sub-meshes of the base mesh is used, according to some embodiments.

At block 1302, a decoder receives a bit stream for a compressed dynamic mesh, the bit stream comprising sub-mesh data units included in a base mesh sub-bit stream of the bit stream and displacement information included in one or more additional sub-bit streams of the bit stream.

At block 1304, the decoder receives viewing information indicating one or more focus areas for viewing the dynamic mesh. Also, at block 1306, the decoder determines sub-meshes to be included in a reconstructed version of the dynamic mesh based on the viewing information. For example, only a portion of the dynamic mesh may currently be being viewed. In such a situation, the viewing information may be used to select which sub-meshes are to be used in reconstructing the dynamic mesh.

At block 1308, the decoder parses the base mesh sub-bit stream to locate only the necessary sub-mesh data units that are needed for reconstruction. For example, only sub-mesh data units corresponding to portions of the dynamic mesh that are to be included in a reconstructed version of the dynamic mesh may be extracted from the base mesh sub-bit stream. Also, in other embodiments, even if all sub-meshes are to be reconstructed, different prediction techniques may be applied to predict different sub-meshes of the base mesh. Thus, the ability to parse the base mesh sub-bit stream to identify individual sub-meshes (based on sub-mesh data units) may be used in such circumstances.

At block 1310, the at least portion of the base mesh is reconstructed using the sub-mesh information from the sub-mesh data units parsed from the base mesh sub-bit stream at block 1308. Also, at block 1312, displacement information is applied to subdivision locations of the portion of the base mesh reconstructed at block 1310. The application of the displacement information further reconstructs the dynamic mesh to include both vertices of the base mesh and additional vertices added at sub-division locations of the base mesh (or portion of the base mesh and subdivision locations corresponding to the sub-meshes that are to be reconstructed).

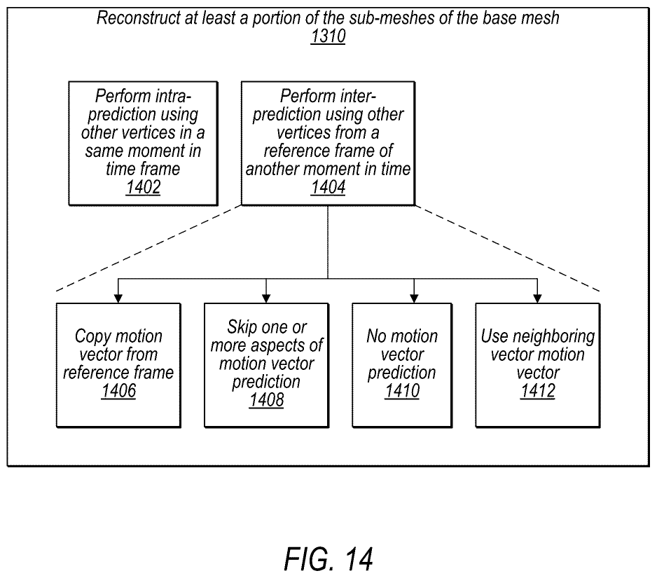

FIG. 14 illustrates different prediction modes that may be applied to predict various portions (e.g. sub-meshes) of a base mesh, according to some embodiments.

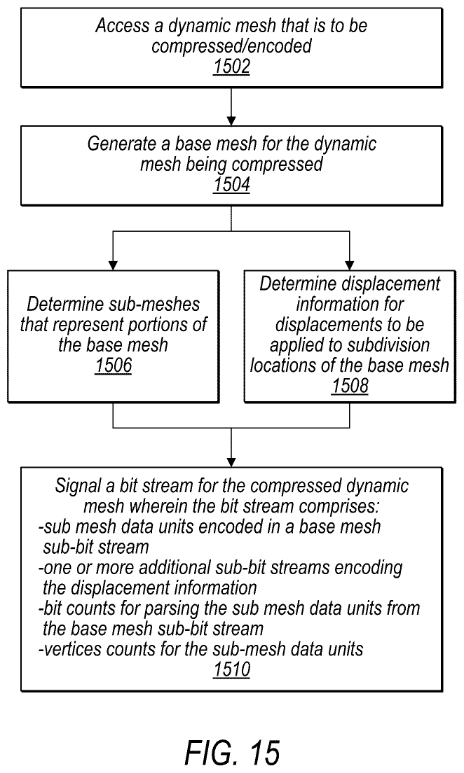

For example, reconstructing the sub-meshes of the base mesh (as performed in block 1310 of FIG. 13) could include performing intra-prediction and/or inter-prediction. For example, at block 1402, vertices of a given sub-mesh of the base mesh are predicted, using intra-prediction, based on vertices values for other vertices in the same moment in time frame (e.g. of the same sub-mesh or another sub-mesh in that moment in time frame). Alternatively, at block 1404 vertices of a given sub-mesh of the base mesh are predicted, using inter-prediction, based on vertices values for corresponding vertices in other moment in time frames, such as a preceding moment in time frame. Also, various inter-prediction techniques may be signaled for different sub-meshes. For example, at block 1406 an inter-prediction technique that copies motion vectors from a reference frame is signaled. Alternatively for one or more aspects of motion vector prediction (such as for the X component, Y component, or Z component of the motion vector) a skip flag may be signaled. In such a case prediction may be skipped and the component value may be encoded in a residual value. Also, at block 1410 a flag indicating no motion vector prediction may be used, in which case the prediction may be a zero value motion vector and any deviation from “no motion” may be signaled using residual values. Also, at block 1412, a flag may be encoded indicating that neighboring motion vectors for neighboring vertices are to be used for prediction. Additional details regarding signaling of prediction types is further provided below, after the discussion of the encoding process in FIG. 15.

FIG. 15 is a flow chart illustrating a process for compressing a dynamic mesh using sub-mesh data units, according to some embodiments.

At block 1502, an encoder accesses a dynamic mesh that is to be compressed/encoded. At block 1504, the encoder generates a base mesh for the mesh being encoded. Then, at block 1504 sub-meshes are determined for the base mesh. Also, at block 1508 displacement values are determined. Then at block 1510, the compressed dynamic mesh is signaled, wherein sub-mesh data units are used to modularly encode the respective sub-meshes of the base mesh. The sub-mesh data units include bit counts that allow individual sub-mesh data units to be parsed from the base mesh sub-bit stream, as well as vertices counts that allow vertices indices to be separately built for each sub-mesh.

In some embodiments, the basemesh sub-bitstream and the size of submesh data excluding the size of submesh header can be explicitly signaled as well as the number of vertices for the current submesh. Also, the submeshes in the basemesh sub-bitstream can be inter predicted. The reference frames may be listed by a designated syntax element, bmesh_ref_list_struct. In the inter prediction of submeshes, the motion vectors can be derived from the motion vectors of other vertices in the same submesh. This can be explicitly indicated by per-vertex flags. The functionality can be turned off by a governing flag at the beginning of the inter prediction data unit. Also, the motion vectors can be derived as 0 (e.g., skipped or said another way the vertex of a later sub-mesh may have a same location as a corresponding vertex in a reference sub-mesh, e.g., no motion) when a designated per-vertex flags indicates so. In some embodiments, these flags can be signaled as prediction modes instead of flags.

In the basemesh sub-bitstream, the inter prediction between mesh frames is allowed with the reference frame list structure.

### B.1.1 Basmesh Submesh Layer RBSP Syntax

In the basemesh sub-bitstream, the submeshes are delivered in NAL units as shown below.

Descriptor

```
bmesh_submesh_layer_rbsp( NumBytesRbsp ) {
  submesh_header( )
  submesh_data_unit( mfh_submesh_type, SubMeshUnitSize )
  rbsp_trailing_bits( )
}
```

NumBytesRbsp equals to NumBytesInNalUnit−2. And SubMeshUnitSize equals to NumBytesRbsp−submesh_header_size. submesh_header_size indicates the size occupied by submesh_header( ) in byte.

### B.1.2 Basemesh Submesh Data Unit Syntax

Descriptor

```
submesh_data_unit( subMeshID, unitSize ) {
  if( smh_type == I_SUBMESH ) {
    sdu_intra_sub_mesh_unit( subMeshID, unitSize )
  }
  else if( smh_type == P_SUBMESH ) {
    sdu_inter_sub_mesh_unit( subMeshID, unitSize )
  }
  else if( smh_type == SKIP_SUBMESH ) {
    sdu_skip_sub_mesh_unit( subMeshID )
  }
}
```

### B.1.3 Basemesh Intra Submesh Data Unit Syntax

To use different static mesh codecs based on the profile and the 4cc codec is signalled, sdu_intra_sub_mesh_unit( ) can be abstracted.

| | Descriptor |
|---|---|
| sdu_intra_sub_mesh_unit( subMeshID , unit_size ) { | |
| sismu_intra_unit_size | u(v) |
| sismu_intra_unit( subMeshID , sismu_inter_unit_size) | |
| } | |

sismu_intra_unit(subMeshID, sismu_intra_unit_size) contains a portion of mesh data of size sismu_intra_unit_size. The syntax of sismu_intra_unit is defined by the value of bmptl_profile_codec_group_idc or an associated 4CC code as defined by a component codec mapping SLI message. When sismu_intra_unit_size is signalled, the bit count required to signal it is signalled in the frame parameter set.

In another embodiment, sismu_intra_unit_size is not signalled but inferred as unit_size.

### B.1.4 Basemesh Inter Submesh Data Unit Syntax

| | Descriptor |
|---|---|
| spdu_inter_sub_mesh_unit( subMeshID , unit_size ) { | |
| sismu_inter_unit_size | u(v) |
| if( smh_num_ref_idx_active_minus1 > 0 ) | |
| sismu_ref_index | ue(v) |
| sismu_inter_vertex_count | ue(v) |
| sismu_inter_unit( subMeshID ,sismu_inter_vertex_count , | |
| sismu_inter_unit_size) | |
| } | |

sismu_inter_unit(subMeshID, sismu_inter_vertex_count, sismu_inter_unit_size) contains a portion of mesh data of size sismu_inter_unit_size. The syntax of sismu_inter_unit is defined by the value of bmptl_profile_codec_groupjidc or an associated 4CC code as defined by a component codec mapping SEI message. When sismu_inter_unit_size is signalled, the bit count required to signal it is signalled in the frame parameter set.

In another embodiment, sismu_inter_unit_size is not signalled but inferred as unit_size−(size of sismu_ref_index and sismu_inter_vertex_count).

### B.1.5 Basemesh Inter Submesh Data Unit Default Syntax (1)

When the profile and 4cc codec id indicates the motion codec is the default internal motion codec, sdu_inter_sub_mesh_unit_default( ) is signalled for sismu_inter_unit( ). In an embodiment, vertexCount can be derived as the number of vertices in the reference mesh.

| | Descriptor |
|---|---|
| sdu_inter_sub_mesh_unit_default ( subMeshID, vertexCount , unitSize) { | |
| for( v = 0; v < vertexCount; v++ ) { | |
| sismu_mv_pred_mode[ subMeshID ][ v ] | ae(v) |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) { | |
| sismu_mv_residual_abs_rem[ subMeshID ][ v ][ k ] | ae(v) |
| } | |
| } | |
| } | |
| } | |
| } | |

### B.1.6 Basemesh Inter Submesh Data Unit Default Syntax (2)

When sdu_inter_sub_mesh_unit_default( ) is used, the motion vectors can be signalled based on a flag signalled per vertex. sismu_copied_mv_flag can be coded by 1 bit fixed length or can be context based arithmetic coded.

| | Descriptor |
|---|---|
| sdu_inter_sub_mesh_unit_default ( subMeshID, vertexCount, unitSize ) { | |
| if(vertexCount>0) | |
| sismu_copied_mv_present_flag[ subMeshID ] | u(1) |
| for( v = 0; v < vertexCount; v++ ) { | |
| if( sismu_copied_mv_present_flag[ subMeshID ] && v>0) | |
| sismu_copied_mv_flag[ subMeshID ][ v ] | u(1)/ ae(v) |
| else | |
| sismu_copied_mv_flag[ subMeshID ][v] = 0 | |
| if( !sismu_copied_mv_flag[ subMeshID ][ v ]) { | |
| sismu_mv_pred_mode[ subMeshID ][ v ] | ae(v) |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) | |
| sismu_mv_residual_abs_rem[ subMeshID ][ v ][ k ] | ae(v) |
| } | |
| } //for | |
| }//if | |
| }//for | |
| } | |

### B.1.7 Basemesh Inter Submesh Data Unit Default Syntax (3)

In another embodiment, a set of sismu_copied_mv_flag can be signalled before the residuals are signalled:

| | Descriptor |
|---|---|
| sdu_inter_sub_mesh_unit_default ( subMeshID, vertexCount, unitSize ) { | |
| if(vertexCount>0) | |
| sismu_copied_mv_present_flag[ subMeshID ] | u(1) |
| for( v = 0; v < vertexCount; v++ ) { | |
| if( sismu_copied_mv_present_flag[ subMeshID ] && v>0) | |
| sismu_copied_mv_flag[ subMeshID ][ v ] | u(1)/ ae(v) |
| else | |
| sismu_copied_mv_flag[ ][v] = 0 | |
| for( v = 0; v < vertexCount; v++ ) { | |
| if( !sismu_copied_mv_flag[ subMeshID ][ v ]) { | |
| sismu_mv_pred_mode[ subMeshID ][ v ] | ae(v) |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) | |
| sismu_mv_residual_abs_rem[ subMeshID ][ v ][ k ] | ae(v) |
| } | |
| } //for | |
| }//if | |
| }//for | |
| } | |

B.1.8 Basemesh Inter Submesh Data Unit Default Syntax with Skipped Motion Vectors

When sdu_inter_sub_mesh_unit_default( ) is used, the motion vectors can be derived as 0 vector based on a flag signalled per vertex. sismu_skip_mv_fag can be coded by 1 bit fixed length or can be context based arithmetic coded.

| | Descriptor |
|---|---|
| sdu_inter_sub_mesh_unit_default ( subMeshID, vertexCount, unitSize ) { | |
| if(vertexCount>0) | |
| sismu_skip_mv_enabled_flag[ subMeshID ] | u(1) |
| for( v = 0; v < vertexCount; v++ ) { | |
| if( sismu_skip_mv_enabled_flag[ subMeshID ] ) | |
| sismu_skip_mv_flag[ subMeshID ][ v ] | u(1)/ ae(v) |
| else | |
| sismu_skip_mv_flag[ subMeshID ][v] = 0 | |
| if( !sismu_skip_mv_flag[ subMeshID ][ v ]) { | |
| sismu_mv_pred_mode[ subMeshID ][ v ] | ae(v) |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) | |
| sismu_mv_residual_abs_rem[ subMeshID ][ v ][ k ] | ae(v) |
| } | |
| } //for | |
| }//if | |
| }//for | |
| } | |

In another embodiment, a set of sismu_skip_mv_flag whose size is vertexCount can be signalled before the residuals are signalled.

When sismu_skip_mv_flag and sismu_copied_mv_flag are signalled together, any of two can come first.

B.1.9 Basemesh Inter Submesh Data Unit Default Syntax with Skip Motion Vectors and Copy Motion Vectors

In another embodiment, when both skip motion vectors and copy motion vectors are enabled, skip motion vector flags does not need to be signaled but derived.

| | Descriptor |
|---|---|
| sdu_inter_sub_mesh_unit_default ( subMeshID, vertexCount, unitSize ) { | |
| if(vertexCount>0){ | |
| sismu_copied_mv_present_flag[ subMeshID ] | u(1) |
| sismu_skip_mv_enabled_flag[ subMeshID ] | u(1) |
| } | |
| for( v = 0; v < vertexCount; v++ ) { | |
| if( sismu_skip_mv_enabled_flag[ subMeshID ] \|\| | |
| sismu_copied_mv_present_flag[ subMeshID ]) | |
| sismu_mv_signalled_flag[ subMeshID ][ v ] | u(1)/ ae(v) |
| else | |
| sismu_mv_signalled_flag[ subMeshID ][v] = 0 | |
| if( sismu_mv_signalled_flag[ subMeshID ][ v ]) { | |
| sismu_mv_pred_mode[ subMeshID ][ v ] | ae(v) |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) | |
| sismu_mv_residual_abs_rem[ subMeshID ][ v ][ k ] | ae(v) |
| } | |
| } //for | |
| }//if | |
| }//for | |
| } | |

B.1.10 Basemesh Inter Submesh Data Unit Default Syntax with Motion Vector Grouping

V-DMC also adopted motion vector prediction grouping. the group size, bmsps_inter_mesh_motion_group_size_minus1 is signalled in the sequence parameter set. In sdu_inter_sub_mesh_unit_default, (bmsps_inter_mesh_motion_group_size_minus1+1) motion vectors have the same motion vector prediction mode.

| | Descriptor |
|---|---|
| bmesh_sequence_parameter_set_rbsp( ) { | |
| ... | u(8) |
| bmsps_inter_mesh_motion_group_size_minus1 | u(8) |
| ... | |
| } | |

In another embodiment, (bmsps_inter_mesh_motion_group_size)-motion vectors have the same motion vector prediction mode.

In another embodiment, (bmsps_inter_mesh_motion_group_size) can be signalled per submesh instead of the sequence parameter set.

### B.1.11 Combination of Motion Vector Grouping and Motion Vector Prediction Skipping

When motion vector grouping is used with skipped and or copied motion vector, the skipped motion vectors and the copied motion vectors can be counted towards the number of the group. For example, when motion vector group size is 16, 16 motion vectors from the first vertex belong to group 0. In another embodiment, skipped motion vectors and copied motion vectors are not counted towards the group. For example, when motion vector group size is 16, 16 motion vectors from the first vertex except skipped or copied motion vectors belong to group 0. B.1.9 can be also combined with motion vector group equivalently.

| | Descriptor |
|---|---|
| sdu_inter_sub_mesh_unit_default ( subMeshID, vertexCount, unitSize ) { | |
| if(vertexCount>0){ | |
| sismu_copied_mv_present_flag[ subMeshID ] | u(1) |
| sismu_skip_mv_enabled_flag[ subMeshID ] | u(1) |
| } | |
| for( v = 0; v < vertexCount; v++ ) { | |
| if( sismu_copied_mv_present_flag[ subMeshID ] ) | |
| sismu_copied_mv_flag[ subMeshID ][ v ] | ue(v)/ |
| | ae(v) |
| else | |
| sismu_copied_mv_flag [ subMeshID ][v] = 0 | |
| if( sismu_skip_mv_enabled_flag[ subMeshID ] ) | |
| sismu_skip_mv_flag[ subMeshID ][ v ] | u(1)/ |
| | ae(v) |
| else | |
| sismu_skip_mv_flag[ subMeshID ][v] = 0 | |
| } | |
| GroupSize = (bmsps_inter_mesh_motion_group_size_minus1+1) | |
| for( v = 0; v < vertexCount; v+= GroupSize ) { | |
| sismu_mv_pred_mode[ subMeshID ][ v ] | ae(v) |
| if(vertexCount− | |
| v<(bmsps_inter_mesh_motion_group_size_minus1+1)) | |
| GroupSize = vertexCount−v | |
| for( v0 = 0; v0 < GroupSize && v+v0 < vertexCount; v0++ ) { | |
| if( !sismu_copied_mv_flag[ subMeshID ][ v+v0 ] && !sismu_skip_mv_fl | |
| ag[ subMeshID ][ v ] ) { | |
| for( k = 0; k < 3; k++ ) { | |
| sismu_mv_residual_abs_gt0[ subMeshID ][ v+v0 ][ k ] | ae(v) |
| if (sismu_mv_residual_abs_gt0[ subMeshID ][ v+v0 ][ k ]) { | |
| sismu_mv_residual_sign[ subMeshID ][ v+v0 ][ k ] | ae(v) |
| sismu_mv_residual_abs_gt1[ subMeshID ][ v+v0 ][ k ] | ae(v) |
| if (sismu_mv_residual_abs_gt1[ subMeshID ][ v+v0 ][ k ]) | |
| sismu_mv_residual_abs_rem[ subMeshID ][ v+v0 ][ k ] | se(v) |
| } | |
| } //for(k) | |
| } //if | |
| else { | |
| GroupSize++ | |
| } | |
| }//for(v0) | |
| }//for(v) | |
| } | |

### B.1.12 Extended Motion Vector Mode

In another embodiment, when sdu_inter_sub_mesh_unit_default( ) is used, the motion vectors can be calculated based on the mode assigned to each vertex instead of indication flags. The name association to sismu_mv_pred_mode can be as follow.

| sismu_mv_pred_ | Name of |
|---|---|
| mode | sismu_mv_pred_mode |
| 0 | MV_SKIP |
| 1 | MV_COPIED |
| 2 | MV_PRED_NONE |
| 3 | MV_PRED_NEIGHBOUR |
| 4 - . . . | RESERVED |

When sismu_mv_pred_mode is MV_COPIED, the motion vector is not signalled but derived from other vertex(motion vector) in the same submehs. When sismu_mv_pred_mode is MV_SKIP the motion vector is not signalled but derived as 0 vector.

| | Descriptor |
|---|---|
| sdu_inter_sub_mesh_unit_default ( subMeshID, vertexCount, unitSize ) { | |
| if(vertexCount>0) | |
| sismu_copied_mv_present_flag[ subMeshID ] | u(1) |
| sismu_skip_mv_enabled_flag[ subMeshID ] | u(1) |
| for( v = 0; v < vertexCount; v++ ) { | |
| sismu_mv_pred_mode[ subMeshID ][ v ] | ae(v) |
| if( sismu_mv_pred_mode [ subMeshID ][ v ]!= | |
| MV_PRED_COPIED && sismu_mv_pred_mode [ subMeshID ][ v ]!= | |
| MV_PRED_SKIP) { | |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) | |
| sismu_mv_residual_abs_rem[ subMeshID ][ v ][ k ] | se(v) |
| } | |
| } //for | |
| }//if | |
| }//for | |
| } | |

The binarization of sismu_mv_pred_mode can vary depending on the governing flags.

| | binarization | | | |
|---|---|---|---|---|
| | | sismu_skip_mv_ | sismu_skip_mv_ | sismu_skip_ |
| | | enabled_flag = | enabled_flag = | mv_enabled_ |
| | sismu_skip_mv_ | 1 | 0 | flag = 0 |
| Name of | enabled_flag = 1 | sismu_copied_ | sismu_copied_ | sismu_copied_ |
| sismu_mv_pred_ | sismu_copied_mv_ | mv_present_ | mv_present_fla | mv_present |
| mode | present_flag = 1 | flag = 0 | g = 1 | flag = 0 |
| MV_SKIP | 0 | 0 | x | x |
| MV_COPIED | 10 | x | 0 | x |
| MV_PRED_NONE | 110 | 10 | 10 | 0 |
| MV_PRED_ | 111 | 11 | 11 | 1 |
| NEIGHBOUR | | | | |

In another embodiment, he binarization of sismu_mv_pred_mode can be as follows:

| | binarization | | | |
|---|---|---|---|---|
| | | sismu_skip_mv_ | sismu_skip_mv_ | sismu_skip_ |
| | | enabled_flag = | enabled_flag = | mv_enabled_ |
| | sismu_skip_mv_ | 1 | 0 | flag = 0 |
| | enabled_flag = 1 | sismu_copied_ | sismu_copied_ | sismu_copied_ |
| Name of | sismu_copied_mv_ | mv_present_ | mv_present_fla | mv_present |
| sismu_mv_pred_mode | present_flag = 1 | flag = 0 | g = 1 | flag = 0 |
| MV_SKIP | 00 | 0 | x | x |
| MV_COPIED | 01 | x | 0 | x |
| MV_PRED_NONE | 10 | 10 | 10 | 0 |
| MV_PRED_NEIGHBOUR | 11 | 11 | 11 | 1 |

When they are arithmetic coded, the context used for each bin can be different based on sismu_skip_mv_enabled_flag and sismu_copied_mv_present_flag.

### B.1.13 Extended Motion Vector Mode(2)

In another embodiment, the indication of the motion vectors are copied(MV_PRED_COPIED) or the motion vectors are derived as a zero vector(MV_PRED_SKIP) for the vertices can be signalled before the residuals are signalled. sismu_mv_skip_type can be as follow:

| | Name of |
|---|---|
| sismu_mv_skip_type | sismu_mv_skip_type |
| 0 | MV_PRESENT |
| 1 | MV_DERIVE_SKIP |
| 2 | MV_DERIVE_COPY |
| 3 - . . . | RESERVED |

In this case the prediction mode, sismu_mv_pred_mode can be 0 or 1. MvPredMode derived from sismu_mv_pred_mode and sismu_mv_skip_type can be as follows:

| MvPredMode | Name of MvPredMode |
|---|---|
| 0 | MV_SKIP |
| 1 | MV_COPIED |
| 2 | MV_PRED_NONE |
| 3 | MV_PRED_NEIGHBOUR |
| 4 - . . . | RESERVED |

| | Descriptor |
|---|---|
| sdu_inter_sub_mesh_unit_default ( subMeshID, vertexCount, unitSize ) { | |
| if(vertexCount>0) | |
| sismu_copied_mv_present_flag[ subMeshID ] | u(1) |
| sismu_partial_skip_enabled_flag[ subMeshID ] | u(1) |
| for( v = 0; v < vertexCount; v++ ) { | |
| if( sismu_copied_mv_present_flag[ subMeshID ] \|\| | |
| sismu_partial_skip_enabled_flag[ subMeshID ]) | |
| sismu_mv_skip_type[ subMeshID ][ v ] | ue(v)/ |
| | ae(v) |
| else | |
| sismu_mv_skip_type[ subMeshID ][v] = 0 | |
| for( v = 0; v < vertexCount; v++ ) { | |
| sismu_mv_pred_mode[ subMeshID ][ v ] | ae(v) |
| if( sismu_mv_skip_type [ subMeshID ][ v ]== MV_PRESENT) { | |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) | |
| sismu_mv_residual_abs_rem[ subMeshID ][ v ][ k ] | se(v) |
| } | |
| } //for | |
| }//if | |
| }//for | |
| } | |

In the basemesh sub-bitstream, bmesh_profile_toolset_constraints_information( ) is signalled to indicate the restrictions on the tools to be used for the bitstream. A flag to indicate the motion vector copy, MV_PRED_COPIED, is enabled or not can be signalled in bmesh_profile_toolset_constraints_information( ). When bmptc_mv_copy_enabled_flag is 0 sismu_copied_mv_present_flag should be always 0 in the conformed bitstreams and the related functions are not invoked.

Also there can be a flag to indicate skip motion vectors are used or not in bmesh_profile_toolset_constraints_information( ). When bmptc_skip_mv_enabled_flag is 0, sismu_skip_mv_enable_flag should be always 0 in the conformed bitstreams and the related functions are not invoked.

| | Descriptor |
|---|---|
| bmesh_profile_toolset_constraints_information( ) { | |
| ... | |
| bmptc_mv_copy_enabled_flag | u(1) |
| bmptc_skip_mv_enabled_flag | u(1) |
| ... | |
| } | |

There can be a flag to indicate the motion vector grouping is used or not in bmesh_profile_toolset_constraints_information( ). When bmptc_mv_group_enabled_flag is 0, bmsps_inter_mesh_motion_group_size_minus1 should be always 0 in the conformed bitstreams.

| | Descriptor |
|---|---|
| bmesh_profile_toolset_constraints_information( ) { | |
| ... | |
| bmptc_mv_group_enabled_flag | u(1) |
| ... | |
| } | |

In some embodiments, the motion vector prediction mode MvPredMode is derived from sismu_mv_pred_mode[subMeshID][v] and others as follow:
MvPredMode[subMeshID][v]=sismu_mv_pred_mode[subMeshID][v]

When the indication flags described above are signalled, MvPreMode can be updated as follow:

if(sismu_ copied _mv_flag [ subMeshID ][ v ] )
MvPredMode[ subMeshID ][ v ] = MV_COPIED
if(sismu_skip_mv_flag [ subMeshID ][ v ] )
MvPredMode[ subMeshID ][ v ] = MV_SKIP

When and sismu_copied_mv_flag are signalled together, any of two can performed first.

Instead of signalling two types of flag for copied motion vectors and skip motion vectors, only one flag, mv_signalled_flag is used, firstVertexIndexDuplicated is used to check if the motion vectors are derived as 0 or same as the reference vertex. The derivation is conceptually as follows:

if(!sismu_mv_signalled_flag[ subMeshID ][ v ] ){
if(firstVertexIndexDuplicated(v)==−1)
MvPredMode[ subMeshID ][ v ] = MV_SKIP
else
MvPredMode[ subMeshID ][ v ] = MV_COPIED
}

When motion vector grouping is used, the motion vector prediction mode of the v-th vertex is same as the one signalled for the group the vertex belongs to. When sismu_mv_pred_mode[subMeshID][v] for all v is preset as −1, sismu_mv_pred_mode[subMeshID][v] can be derived conceptually as follow:

lastValidIndex=0
for( v = 0; v < vertexCount; v++ ) {
if(sismu_mv_pred_mode[ subMeshID ][ v ]!=−1) lastValidIndex=v
else
sismu_mv_pred_mode[ subMeshID ][ v ] =
sismu_mv_pred_mode[ subMeshID ][ last ValidIndex ]
}

Based on MvPredMode, currentSubmeshMotionVectors can be derived as follows. If MvPredMode is equal to MV_SKIP, then

```
If MvPredMode is equal to MV_SKIP, then
          currentSubmeshMotionVectors[ v ][ k ] = 0
else if MvPredMode is equal to MV_COPIED, then
              currentSubmeshMotionVectors[ v ][ k ] = currentSubmeshMotionVectors[ vRef ][ k ]
else if MvPredMode is equal to MV_PRED_NONE, then
          currentSubmeshMotionVectors[ v ][ k ] = VertexMotionVectorResiduals[ v ][ k ]
else if MvPredMode is equal to MV_PRED_NEIGHBOUR, then
          currentSubmeshMotionVectors[ v ][ k ] = VertexMotionVectorResiduals
  [ v ][ k ] + currentSubmeshPredictedMotionVectors[ v ][ k ]
                vRef is derived as follow:
  vRef =firstVertexIndexDuplicated(v) where
  firstVertexIndexDuplicated(v){
    for( i = 0; i<v; i++){
        if(referenceSubmeshVertexPositions[ i ] == referenceSubmeshVertexPositions[ v ])
            return i
      }
      return −1
  }
if vRef =−1, currentSubmeshMotionVectors[ v ][ k ] is set as 0.
```

The reconstructed geometry position is derived as follow when referenceSubmeshVertexPositions [v][k] indicates the k-th component of the geometry position of the v-th vertex in the reference submesh.

currentSubmeshVertexPositions[v][k]=referenceSubmeshVertexPositions[v][k]+currentSubmeshMotionVectors[v][k]

When vertexCount is greater than the number of vertices of the reference frame, then the motion vector, currentSubmeshMotionVectors[v] where v is greater than the number of vertices of the reference frame, is inferred as 0.

### Example Computer System

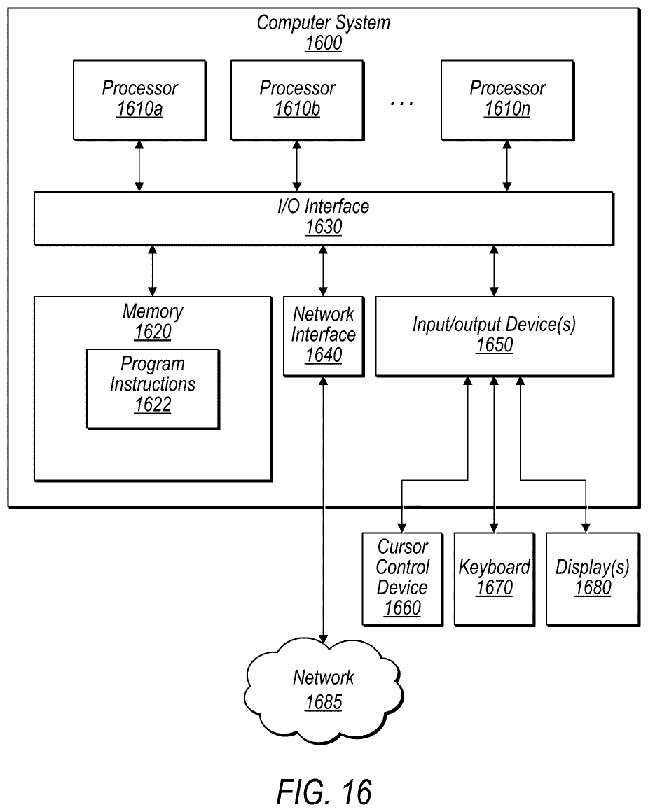

FIG. 16 illustrates an example computer system 1600 that may implement an encoder or decoder or any other ones of the components described herein, (e.g., any of the components described above with reference to FIGS. 1-15), in accordance with some embodiments. The computer system 1600 may be configured to execute any or all of the embodiments described above. In different embodiments, computer system 1600 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, a consumer device, video game console, handheld video game device, application server, storage device, a television, a video recording device, a peripheral device such as a switch, modem, router, or in general any type of computing or electronic device.

Various embodiments of a point cloud encoder or decoder, as described herein may be executed in one or more computer systems 1600, which may interact with various other devices. Note that any component, action, or functionality described above with respect to FIGS. 1-15 may be implemented on one or more computers configured as computer system 1600 of FIG. 16, according to various embodiments. In the illustrated embodiment, computer system 1600 includes one or more processors 1610 coupled to a system memory 1620 via an input/output (I/O) interface 1630. Computer system 1600 further includes a network interface 1640 coupled to I/O interface 1630, and one or more input/output devices 1650, such as cursor control device 1660, keyboard 1670, and display(s) 1680. In some cases, it is contemplated that embodiments may be implemented using a single instance of computer system 1600, while in other embodiments multiple such systems, or multiple nodes making up computer system 1600, may be configured to host different portions or instances of embodiments. For example, in one embodiment some elements may be implemented via one or more nodes of computer system 1600 that are distinct from those nodes implementing other elements.

In various embodiments, computer system 1600 may be a uniprocessor system including one processor 1610, or a multiprocessor system including several processors 1610 (e.g., two, four, eight, or another suitable number). Processors 1610 may be any suitable processor capable of executing instructions. For example, in various embodiments processors 1610 may be general-purpose or embedded processors implementing any of a variety of instruction set architectures (ISAs), such as the x86, PowerPC, SPARC, or MIPS ISAs, or any other suitable ISA. In multiprocessor systems, each of processors 1610 may commonly, but not necessarily, implement the same ISA.

System memory 1620 may be configured to store point cloud compression or point cloud decompression program instructions 1622 and/or sensor data accessible by processor 1610. In various embodiments, system memory 1620 may be implemented using any suitable memory technology, such as static random-access memory (SRAM), synchronous dynamic RAM (SDRAM), nonvolatile/Flash-type memory, or any other type of memory. In the illustrated embodiment, program instructions 1622 may be configured to implement an image sensor control application incorporating any of the functionality described above. In some embodiments, program instructions and/or data may be received, sent or stored upon different types of computer-accessible media or on similar media separate from system memory 1620 or computer system 1600. While computer system 1600 is described as implementing the functionality of functional blocks of previous Figures, any of the functionality described herein may be implemented via such a computer system.

In one embodiment, I/O interface 1630 may be configured to coordinate I/O traffic between processor 1610, system memory 1620, and any peripheral devices in the device, including network interface 1640 or other peripheral interfaces, such as input/output devices 1650. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments some or all of the functionality of I/O interface 1630, such as an interface to system memory 1620, may be incorporated directly into processor 1610.

Network interface 1640 may be configured to allow data to be exchanged between computer system 1600 and other devices attached to a network 1685 (e.g., carrier or agent devices) or between nodes of computer system 1600. Network 1685 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1650 may, in some embodiments, include one or more display terminals, keyboards, keypads, touchpads, scanning devices, voice or optical recognition devices, or any other devices suitable for entering or accessing data by one or more computer systems 1600. Multiple input/output devices 1650 may be present in computer system 1600 or may be distributed on various nodes of computer system 1600. In some embodiments, similar input/output devices may be separate from computer system 1600 and may interact with one or more nodes of computer system 1600 through a wired or wireless connection, such as over network interface 1640.

As shown in FIG. 16, memory 1620 may include program instructions 1622, which may be processor-executable to implement any element or action described above. In one embodiment, the program instructions may implement the methods described above. In other embodiments, different elements and data may be included. Note that data may include any data or information described above.

Those skilled in the art will appreciate that computer system 1600 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1600 may be transmitted to computer system 1600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component.

1. One or more non-transitory computer-readable storage media storing program instructions that, when executed using one or more processors, cause the one or more processors to:
receive a bit stream for a dynamic mesh, the bit stream comprising:
a base mesh sub-bitstream comprising information for a base mesh, wherein the base mesh sub-bitstream is signaled using a plurality of sub-mesh data units corresponding to a plurality of respective sub-meshes included in the base mesh; and
one or more additional sub-bitstreams comprising displacement information for displacements that are to be applied to sub-division locations of the base mesh,
parse the base mesh sub-bitstream to determine, based on information signaled in respective ones of the sub-mesh data units:
vertices counts for the respective sub-meshes;
reconstruct at least a portion of the plurality of sub-meshes signaled in the base mesh sub-bitstream using the vertices counts parsed from the base mesh sub-bitstream; and
apply at least a portion of the displacement information to sub-division locations of the reconstructed portion of the sub-meshes.

2. The one or more non-transitory computer-readable storage media of claim 1, wherein the program instructions, when executed using the one or more processors, cause the portion of the plurality of sub-meshes to be reconstructed in a different order than an order in which the corresponding sub-mesh data units are signaled in the base mesh sub-bit stream.

3. The one or more non-transitory computer-readable storage media of claim 1, wherein the program instructions, when executed using the one or more processors, further cause the one or more processors to:
receive viewing information indicating one or more focus areas of the dynamic mesh that are a focus for viewing a reconstructed version of the dynamic mesh; and
identify sub-mesh data units corresponding to sub-meshes located in the one or more focus areas,
wherein said reconstructing the at least a portion of the plurality of sub-meshes signaled in the base mesh sub-bitstream using the vertices counts parsed from the base mesh sub-bitstream and said applying the at least a portion of the displacement information to the sub-division locations of the reconstructed portion of the sub-meshes is performed for the sub-meshes corresponding to the identified sub-mesh data units without requiring all sub-meshes signaled in the base mesh sub-bitstream to be reconstructed.

4. The one or more non-transitory computer-readable storage media of claim 1, wherein to reconstruct the at least a portion of the plurality of sub-meshes signaled in the base mesh sub-bitstream using the vertices counts parsed from the base mesh sub-bitstream, the program instructions, when executed on or across the one or more processors, cause the one or more processors to perform one or more of:
intra-prediction within a point in time frame to determine vertex positions of the vertices of the respective sub-meshes being reconstructed; or
inter-prediction using a preceding reference frame to determine vertex positions of the vertices of the respective sub-meshes being reconstructed.

5. The one or more non-transitory computer-readable storage media of claim 4, wherein, for the inter-prediction, one or more of the following indicators are signaled for respective ones of the vertices being inter-predicted:
a copy motion vector indicator; or
skip one or more aspects of motion vector prediction indicator.

6. The one or more non-transitory computer-readable storage media of claim 5, wherein, for the inter-prediction, one or more of the following additional indicators are further signaled for one or more of the respective ones of the vertices being inter-predicted:
a no motion vector prediction indicator; or
an indicator that motion vector prediction is to be based on a motion vector determined for a neighboring vertex.

7. The one or more non-transitory computer-readable storage media of claim 6, wherein the base mesh sub-bitstream further comprises:
a toolset constraint indicator that is signaled to indicate only a sub-set of an overall set of available predictors are to be used for inter-prediction for a portion of the base mesh sub-bitstream, wherein a different binarization is used to signal the predictors for the sub-set when the toolset constraint indicator is signaled.

8. The one or more non-transitory computer-readable storage media of claim 7 wherein the toolset constraint indicator is signaled using one or more disablement flags for one or more types of motion vector predictors or for motion vector copying.

9. The one or more non-transitory computer-readable storage media of claim 1, wherein, to reconstruct the at least a portion of the plurality of sub-meshes signaled in the base mesh sub-bitstream, the program instructions, when executed using the one or more processors, further cause the one or more processors to:
determine, for respective ones of the vertices of the sub-meshes being reconstructed, a motion vector prediction mode to be used to predict a vertex position for that respective vertex; and
apply a signaled residual value to the predicted vertex value.

10. The one or more non-transitory computer-readable storage media of claim 9, wherein:
respective sets of vertices of the portion of the sub-meshes to be reconstructed are grouped, and wherein prediction information is signaled differently for different groupings.

11. The one or more non-transitory computer-readable storage media of claim 9, wherein different prediction modes are signaled for predicting different vertices values for vertices included in a same point in time frame for the dynamic mesh.

12. The one or more non-transitory computer-readable storage media of claim 9, wherein different flag schemas are used by respective ones of the sub-mesh data units to signal the different prediction modes for different respective sub-meshes corresponding to respective ones of the sub-mesh data units.

13. The one or more non-transitory computer-readable storage media of claim 1, wherein the vertices counts for the respective sub-meshes are signaled in supplemental enhancement information (SEI) messages included in the bit stream.

14. The one or more non-transitory computer-readable storage media of claim 1, wherein the vertices counts for the respective sub-meshes are signaled in headers of network abstraction layer (NAL) units included in the base mesh sub-bit stream.

15. The one or more non-transitory computer-readable storage media of claim 1, wherein the vertices counts for the respective sub-meshes are signaled in a format that is agnostic to decoder type to be used to reconstruct the dynamic mesh.

16. One or more non-transitory computer-readable storage media storing program instructions that, when executed using one or more processors, cause the one or more processors to:
generate a base mesh for a dynamic mesh being compressed; and
determine displacement information for displacements that are to be applied to sub-division locations of the base mesh;
determine sub-meshes that represent portions of the base mesh; and
signal:
a base mesh sub-bit stream comprising a plurality of sub-mesh data units corresponding to respective ones of the sub-meshes of the base mesh; and
one or more additional sub-bitstreams comprising the displacement information for the displacements that are to be applied to the sub-division locations of the base mesh,
wherein:
vertices counts for the respective sub-meshes corresponding to the respective sub-mesh data units
are signaled for the sub-mesh data units.

17. The one or more non-transitory computer-readable storage media of claim 16, wherein the information included in the sub-mesh data units further comprises respective frame IDS for point-in-time frames of the dynamic mesh to which the respective sub-mesh data units belong.

18. The one or more non-transitory computer-readable storage media of claim 16, wherein the the vertices counts for the respective sub-meshes are signaled in supplemental enhancement information (SEI) messages included in the bit stream.

19. The one or more non-transitory computer-readable storage media of claim 16, wherein the vertices counts for the respective sub-meshes are signaled in headers of network abstraction layer (NAL) units included in the base mesh sub-bit stream.

20. A device, comprising:
a display;
a memory storing program instructions; and
one or more processors, wherein the program instructions, when executed using the one or more processors, cause the one or more processors to:
receive a bit stream for a dynamic mesh, the bit stream comprising:
a base mesh sub-bitstream comprising information for a base mesh, wherein the base mesh sub-bitstream is signaled using a plurality of sub-mesh data units corresponding to a plurality of respective sub-meshes included in the base mesh; and
one or more additional sub-bitstreams comprising displacement information for displacements that are to be applied to sub-division locations of the base mesh,
parse the base mesh sub-bitstream to determine, based on information signaled in respective ones of the sub-mesh data units, which include:
vertices counts for the respective sub-meshes;
reconstruct at least a portion of the plurality of sub-meshes signaled in the base mesh sub-bitstream using and vertices counts parsed from the base mesh sub-bitstream; and
apply at least a portion of the displacement information to sub-division locations of the reconstructed portion of the sub-meshes; and
cause a reconstructed version of the dynamic mesh to be displayed on the display of the device, wherein the reconstructed version of the dynamic mesh comprises the reconstructed sub-meshes of the base mesh and additional vertices added at sub-division locations, wherein respective positions of the additional vertices have been adjusted by the applying of the at least a portion of the displacement information.
